(19) United States
(12) Patent Application Publication
(10) Pub. No.: US 2009/0319905 A1
(43) Pub. Date: Dec. 24, 2009

(54) SYSTEM AND METHOD FOR REALTIME MONITORING OF RESOURCE CONSUMPTION AND INTERFACE FOR THE SAME

(75) Inventors: Lorie Loeb, Hartland, VT (US); Evan L. Tice, Hanover, NH (US); Tim Tregubov, Hanover, NH (US); Luke M. Wachter, Berleley, CA (US)

Correspondence Address: LOGINOV & ASSOCIATES, PLLC, 10 WATER STREET, CONCORD, NH, 03301, US

(73) Assignee: TELLEMOTION, INC., Hartland, VT (US)

(21) Appl. No.: 12/429,182

(22) Filed: Apr. 23, 2009

Related U.S. Application Data
(60) Provisional application No. 61/074,800, filed on Jun. 23, 2008.

(51) Int. Cl. G06F 3/00

(52) U.S. Cl. 715/736

(57) ABSTRACT

A system and method for real-time monitoring of resource consumption, and interface for displaying resource consumption. System employs plurality of usage monitoring devices to obtain usage data of a particular consumable resource. Usage monitoring devices are in communication with a server environment for polling data and storing the data. The server environment can include a poller, aggregator, database, and administrator configuration site. System environment can have polling application to specify the polling of data. The system environment can also include a mood and analysis application that produces a mood score. The mood score can be presented to an interested individual as a mood-representative display image and/or a three-dimensional scene. An interested individual is presented with an object, such as a display, representative of the environmental impact of the resource consumption. The display is constructed and arranged to motivate an interested individual to reduce resource consumption. The display can be interactive, allowing various information to be displayed and manipulated using, for example, a mouse or touch screen. In general the system and method aids in creating a social norm for the group, allowing individuals therein and other groups to work together to reach a common goal, such as reduced resource consumption.

### RELATED APPLICATIONS

This application claims the benefit of U.S. Provisional Application Ser. No. 61/074,800, filed Jun. 23, 2008, entitled VISUAL CONDITION MONITOR AND METHOD FOR USE, the entire disclosure of which is herein incorporated by reference.

### FIELD OF THE INVENTION

The present invention relates to monitoring consumption of resources, both renewable and nonrenewable, and an interface for the same.

### BACKGROUND OF THE INVENTION

Overconsumption of resources, both renewable and nonrenewable, has become an increasing problem and a global challenge. This problem appears to be accelerating, particularly due to the advance of resource-consuming technologies, population growth, global commerce, and other factors. All of these factors have placed unprecedented pressure on resources, including water, electricity, fossil fuel (coal, natural gas and petroleum), wood and paper products, and a variety of other resource types, which are generally monitorable by various metrologies.

Resource conservation is, in part an individual choice. While the cost for resources can often influence choices to consume or conserve, many situations leave the individual detached from the process and obligation of resource conservation. An example of such a consumption environment is a large institution, such as a corporation, hospital or university, where the cost of energy and other resources is often borne by the institution, and is typically passed indirectly along to clients/customers and/or the participating individuals within the institution (e.g. higher tuition, increases in food and board, etc.). Thus the interested individual has little direct awareness of the specific impact of overconsumption of a particular resource. While many institutions provide awareness information as to resource overconsumption (e.g. labels on light switches admonishing conservation, postings about energy use, informational screen displays, etc.), these do not adequately engage the interested individual in the process and obligation of resource conservation. In general, they may appear as an abstraction to many persons, and lack the emotional motivation to become involved in the greater community effort to conserve.

There is no solution in the prior art that addresses the challenge of meaningfully conveying the consumption of resources by consumers and other persons interested in monitoring and improving consumption. There have been several attempts to monitor based upon displays that give various graphs and other raw consumption data. For example, FIG. 1 shows a prior art system for providing resource consumption information to an interested individual. As depicted, a display 100 on an interested individual's computer screen (e.g. a web page associated with the consumer) provides various information related to that person's consumption of a resource-particularly electricity in that person's home or other metered space. Note the first quadrant 110 shows a standard graph having a curve of consumption versus time that varies through the depicted time period peaks at point 111. This provides the person with his or her raw data of usage. Similarly, quadrant 120 shows a curve having a peak 122, representing a peak in consumption versus time. Quadrant 130 displays a bar graph of power consumption in the form of a number of histograms over given time intervals that vary above and below an average, with a consumption spike indicated at location 131, and a decrease in consumption at location 132. Also, quadrant 140 shows a similar bar graph, having the data normalized to show the overall consumption for a given time period. Note the peaks at locations 142, while the consumption is decreased at bars 143 and 144.

While the display quadrants 110, 120, 130 and 140, serve to provide raw consumption data to an individual in various forms, they still represent a numerical abstraction and provide little additional information as to the effect of their actions on the power consumption. FIG. 2 shows a second prior art display provided to interested individuals via a personal web page or community display screen for conveying consumption data to an interested person or group. This display employs a plotted curve graph window 200 showing a plot of the consumption versus time. Note the various spikes 210 indicate drastic increases in consumption. The horizontal axis of the graph 200 includes a series of day intervals 220, which allow the consumption with respect to each day to be determined by the observer. Again, this graph 200 lacks other meaningful information, such as the desired level of consumption (versus actual), particularly at various parts of the day. Consumption typically falls off during evening hours and peaks during the day and this graph does not address natural variations throughout the day. It is another abstraction of consumption levels in the eyes of the average user.

Further, FIG. 3 shows a third example of a prior art display for conveying consumption data to a person, applicable particularly to an institutional community or group of users Note that the display 300 includes both raw data 310, as well as a histogram bar graph 320 showing consumption. The various bars 330 each represent an instance of consumption data, over the course of one day. After lowering consumption, the graph again peaks at the bar 331, indicating a localized jump in consumption. This is eventually followed by falloff at bar 332, representative of a decrease in consumption. The various peaks and falloffs can be representative of the natural changes in consumption throughout a day, week, month or year. In the case of most institutions, consumption naturally falls during weekends, holidays and vacation periods. This graph does not specifically address such natural ebbs and flows. Likewise, the graph 300 again does not set desired goals for a given period and, more importantly, does not engage the interested individual in the process of conservation.

Rather, each of the energy/resource monitoring approaches illustrated described above with reference to FIGS. 1-3, as well as others contemplated in the prior art, disadvantageously provide an overly technical, abstracted, and not readily digested, representation of the particular consumption pattern. A party interested in monitoring the consumption pattern disadvantageously has little (if any) details about the consumption and how he or she directly affects it. Furthermore, the prior art approaches do not motivate a person to decrease consumption, because there is no other data provided that would indicate to a user what consequences their actions have on power consumption. In addition, these approaches often lack adjustments for the natural ebbs and flows of daily, weekly and seasonal changes in consumption, i.e. even significantly lower consumption at night may still be overconsumption.

It is thus desirable to provide a system and method for effective monitoring and displaying of resource consumption to an interested individual (for example a consumer or distributor/provider) of the resource that engages that individual in the process and obligation of resource conservation. To this end, it is desirable to present feedback, potentially in real-time or near-real-time in the form of a display that is easier to grasp and readily digest by an average individual, and that moves that individual to take positive action to conserve. Moreover, the system and method should be able to account for natural ebbs and flows in resource consumption and provide an effective target for desired consumption taking such ebbs and flows into account.

### SUMMARY OF THE INVENTION

This invention overcomes the disadvantages of the prior art by providing a system and method for real-time monitoring of resource consumption and an interface for the same. The system for monitoring consumption of a resource can include a plurality of usage monitoring devices that obtain usage data. These usage monitoring devices are in communication with a server environment, over a Network such as the world-wide-web, or other types of networks using TCP/IP (Transport Control Protocol/Internet Protocol) or device addresses. Communication between the system elements can also occur using appropriate data feeds to obtain data from web services, including SOAP (Simple Object Access Protocol) and other XML formats over HTTP. The server environment includes a database for storing data polled from the usage monitoring devices, as well as system administrator settings. The server environment further includes an aggregator that pulls the data polled from the usage monitoring devices, and aggregates the data into a set of more streamlined (aggregated) data values. In this manner, repetitive data can be bypassed, as typical resource consumption is the same for a given period of time, such as a second, minute, hour, or day.

The server environment can further comprise a mood and analysis application for producing a mood score in the form of a mood-representative image and/or scene, based upon the aggregated data and system administrator settings. The mood-representative image or scene can be displayed to an interested individual in any of a number of ways, including a computer screen, screen saver widget on a computer, cell phone display, PDA display, kiosk display, or other type of display capable of displaying images.

The system administrator has discretion to determine the frequency and type of polling to be performed, as well as which usage monitoring devices to poll for the data. The polled data is also aggregated according to parameters specified by the system administrator, and can be set for any duration, or other parameter. For example, the aggregator can aggregate all data from the same minute into one single data value. This is then used to determine a probability statistic, by comparing current usage to another type of usage. This can be a usage value in the past (historical data), compared to a value of another monitoring device (competitive probability), or as compared to a targeted, goal value (goal oriented). The system administrator also determines the day and/or time for comparing the usage. The feedback display can be presented to an interested individual in any manner to evoke a meaningful, emotional response within the user to motivate them to reduce their consumption.

In an illustrative embodiment the mood image can comprise a sympathetic character, which evinces various emotional states based upon a consumption state. The state can be based upon a single factor. Alternatively, a more-complex three-dimensional mood state can be created by providing multiple characters and/or a more complex interrelationship between the various factors of consumption (e.g. prevailing weather, time of day, week, etc.). In addition, the display can be interactive, allowing various information to be displayed and manipulated using, for example, a mouse or touch screen. In general the system and method aids in creating a social norm for the group, allowing individuals therein and other groups to work together to reach a common goal, such as reduced resource consumption.

### BRIEF DESCRIPTION OF THE DRAWINGS

The invention description below refers to the accompanying drawings, of which:

FIG. 1, already described, is a first prior art display for conveying consumption data to a person, through the use of curve and bar graphs;

FIG. 2, already described, is a second prior art display for conveying consumption data to a person, through the use of a standard curve graph, on a daily basis;

FIG. 3, already described, is a display according to a third prior art embodiment for conveying consumption data to a person, employing bar graphs;

FIG. 4 is a block diagram showing an overview of a system for real-time consumption monitoring according to an illustrative embodiment;

FIG. 5 is a block diagram showing the flow between the various elements of the system for real-time consumption monitoring according to the illustrative embodiment;

FIG. 6 is a flow diagram of the method for real-time consumption monitoring according to the illustrative embodiment;

FIG. 7 is a diagram of a graphical user interface display showing a nodes management screen for an administrator to manage various nodes representative of a particular location, according to an illustrative embodiment of the consumption monitoring system;

FIG. 8 is a diagram of a graphical user interface display showing the details for a particular node, according to the illustrative embodiment;

FIG. 9 is a diagram of a graphical user interface display showing the screen for editing a particular poller, according to the illustrative embodiment;

FIG. 10 is a diagram of a graphical user interface display showing the testing that can be performed for a particular poller, according to the illustrative embodiment;

FIG. 11 is a diagram of a graphical user interface display showing a set of mood score rules used in polling and aggregating data, according to the illustrative embodiment;

FIG. 12 is a diagram of a graphical user interface display showing a portal editor screen for editing a particular portal to be monitored for consumption, according to the illustrative embodiment;

FIG. 13 is a diagram of a graphical user interface display showing a mood-representation image, according to the illustrative embodiment, in which the mood of a polar bear character is used to convey appropriate consumption, and representative of a first state of consumption;

FIG. 14 is a diagram of a graphical user interface display showing another mood-representation image, according to the illustrative embodiment, in which the mood reveals a second state of consumption;

FIG. 15 is a diagram of a graphical user interface display showing another mood-representation image, according to the illustrative embodiment, in which the mood represents a third state of consumption;

FIG. 16 is a diagram of a graphical user interface display showing another mood-representation image, according to the illustrative embodiment in which the mood represents a fourth state of consumption;

FIG. 17 is a diagram of a graphical user interface display showing another mood-representation image, according to the illustrative embodiment in which the mood represents a fifth state of consumption;

FIG. 18 is a diagram of a graphical user interface display showing another mood-representation image, according to the illustrative embodiment in which the mood represents a sixth state of consumption;

FIG. 19 is a block diagram showing the interaction between the factors influencing mood scoring, and the overall three-dimensional display, according to an illustrative embodiment;

FIG. 20 is a diagram of a three-dimensional graphical user interface display showing a mood-representation scene, according to the illustrative embodiment using a variable image of an adult bear and her cub to display a multi-factor consumption environment;

FIG. 21 is a diagram of a three-dimensional graphical user interface display showing another mood-representation scene, according to the illustrative embodiment, in which a factor has changed causing the bears to become distracted by the butterfly and begin to play with it;

FIG. 22 is a diagram three-dimensional graphical user interface display showing still another mood-representation scene, according to the illustrative embodiment, in which another factor has changed causing the bears to become in distress and the iceberg begins to separate;

FIG. 23 is a diagram of a three-dimensional graphical user interface display showing yet another mood-representation scene, according to the illustrative embodiment, in which the baby cub is drifting away from the adult bear;

FIG. 24 is a diagram of a three-dimensional graphical user interface display showing still another mood-representation scene, according to the illustrative embodiment, in which the cub bear is drifting further away from the adult bear, and the adult bear is crying in despair;

FIG. 25 is a diagram of a three-dimensional graphical user interface display showing another mood-representation scene, according to the illustrative embodiment, in which the cub bear is no longer visible and the adult bear is in great despair;

FIG. 26 is a diagram of a three-dimensional graphical user interface display showing an environmentally-enhanced mood-representation scene, according to the illustrative embodiment, in which the mood-representative scene displays the environment of a polling location, particularly showing in this instance the same weather, as snowing;

FIG. 27 is a diagram of a three-dimensional graphical user interface display showing another environmentally-enhanced mood-representation scene, according to the illustrative embodiment in which the mood-representative scene displays the same time of day as the polling location time of day, night in this display;

FIG. 28 is a diagram of a graphical user interface display including a widget that displays a mood-representation image, according to the illustrative embodiment, in which the widget displays a smaller display of a mood-representative image;

FIG. 29 is a diagram of a graphical user interface display showing a competition-based image representative of consumption relative to others, according to the illustrative embodiment, in which the bears are shown on a platform represents first, second and third place in a competition environment;

FIG. 30 is a diagram of a three-dimensional graphical user interface display showing an environmentally-enhanced mood-representation scene, according to an illustrative embodiment in which the mood-representative scene is activated by a touch-screen interaction and provides a textual content message about the current state of energy consumption or other useful information in combination with the character's prevailing emotion-influencing state;

FIG. 31 is a diagram of a graphical user interface display representing a predetermined mood state (distressed) in connection with the consumption of paper resources, monitored from the sheet-consumption data provided by one or more printers interconnected with the server environment network of the illustrative embodiment.

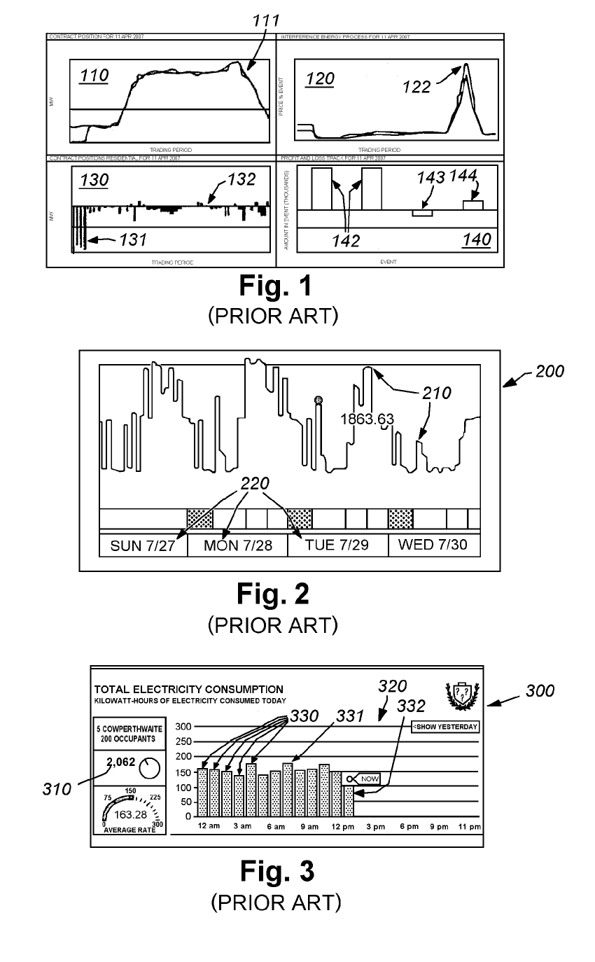

### DETAILED DESCRIPTION

There is provided a system and method for real-time or near-real-time consumption monitoring of resources and an interface for the same. The system and method monitors consumption of any resource, both renewable and nonrenewable, including, electricity, power, water, paper, ink/toner, and any other monitorable or meterable resource.

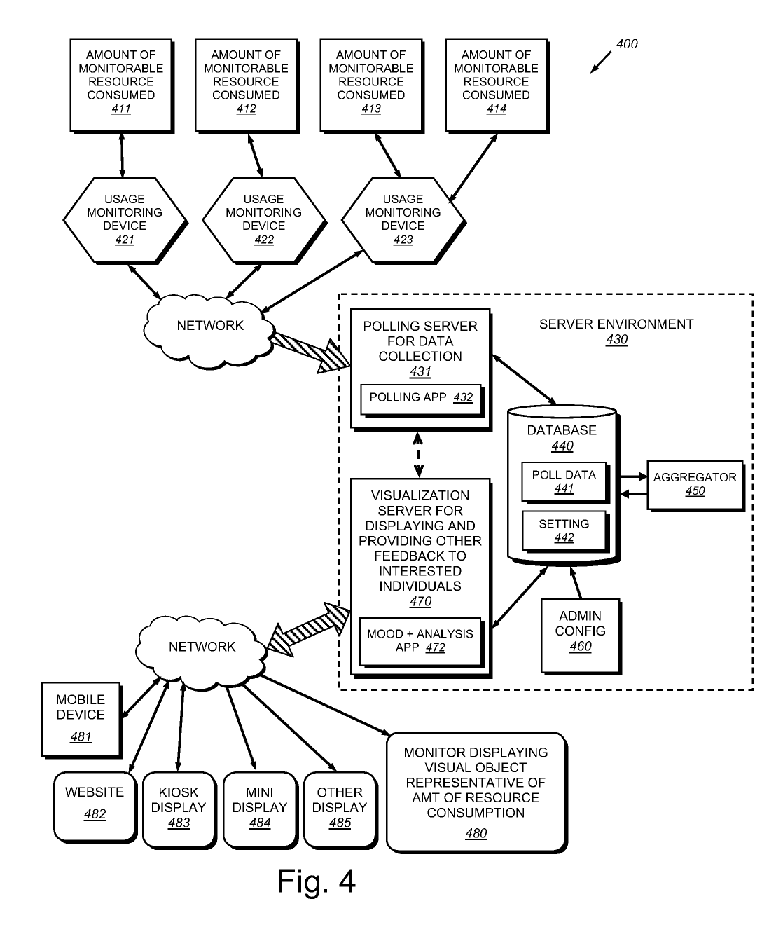

FIG. 4 is a block diagram 400 showing an overview of the interaction of functional and hardware elements within a system for real-time consumption monitoring. The amount of monitorable resource consumed (411, 412, 413 and 414) can be any resource, as disclosed herein, that may be monitored. This can include heat, water, energy, fuel, oil, paper, ink, and any other resource or product. There are a plurality of usage monitoring devices 421, 422, and 423 provided for monitoring the amount of monitorable resource that is consumed in association with each monitoring device. The usage or consumption monitoring devices can comprise any appropriate device capable of determining the amount of resource that has been used. The usage monitoring devices can comprise any appropriate meter, such as an electric meter, water meter, etc., for monitoring consumption. This usage data is transmitted over a network, such as the world-wide-web based Internet, or other types of networks using Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) to poll data from each of the devices located thereon.

FIG. 4 further details a server environment 430, in which the data polling and aggregation of polled data is performed. As shown, the server environment 430 can include a polling server 431, a database 440, an aggregator 450, and administrator configuration site 460, and a visualization server 470. Note that the various functional and physical components of the server environment can reside on individual computing devices and/or device addresses that are appropriately networked, or can be integrated into a single computing device that performs all of the functions of the various components.

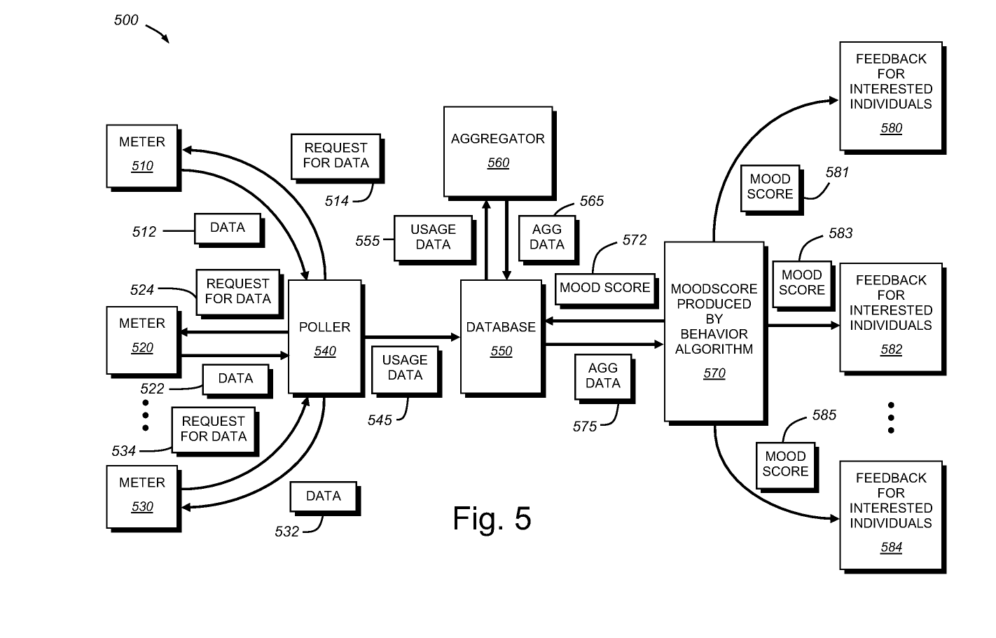

The polling server 431 of the server environment 430 can include a polling application 432 running thereon, for determining the appropriate time, place and any other information to specify the polling of data, as will be discussed below in greater detail with reference to FIG. 5. The database 440 can have polling data 441 stored thereon, which is the polled data retrieved from the usage monitoring devices. Administrative settings (442), as set by the system administrator can also be stored in the database 440. The server environment further includes an aggregator 450 that receives polling data from the database 440, aggregates the data, as determined by the administrator settings as will be described in greater detail below (for example, aggregate all data for one minute into one single piece of data). The aggregator 450 then sends the aggregated data to the database 440 to be stored therein.

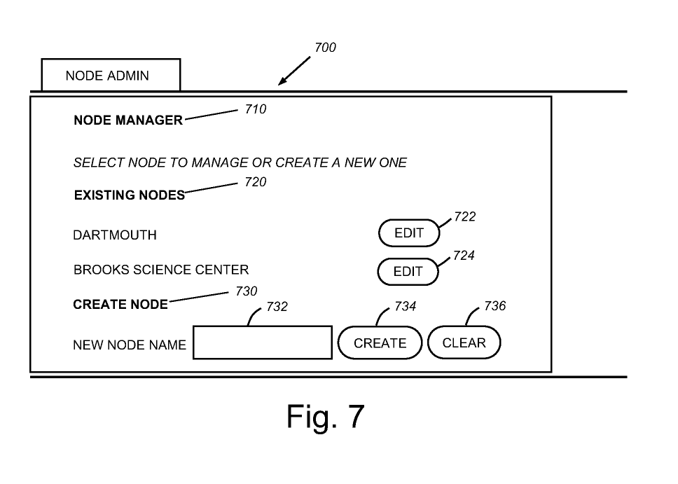

The server environment 430 can also include an administrator configuration site 460, such as those exemplary graphical user interface displays shown in FIGS. 7-11 and the corresponding description hereinbelow. The administration configuration website 460 allows an administrator to set parameters, thereby defining the particular display by which the monitored consumption can be conveyed to an interested individual or group of interested individuals within the community that consumes the resource and whose consumption thereof is monitored. Note that the term “interested individual” can include, among others, personal users of the resource which is the subject of the display, those who are part of a local group of users (e.g. a dormitory floor or building), a wider community that includes users of the resource, or those outside the community of users who have interest in that community's consumption. Basically, as described below, any person or group whose consumption behavior is influenced by the display, or takes interest in the consumption level displayed is an interested individual and target viewer of the system and method contemplated herein. The site 460 can be any type of user interface, such as a standard GUI, or other interface capable of receiving user administration settings as specified by a system administrator. These administrative settings are stored in the database 440 as administrator settings 442, and determine how often to aggregate the data, as well as when and how to perform the polling of data and any other settings specified by a system administrator. In this manner, an administrator can modify the consumption monitoring to poll relevant data as desired to obtain a mood score.

A visualization server 470 can also be provided as part of the server environment 430. The visualization server is responsible for determining and providing feedback to an interested individual. The visualization server 470 includes a mood and analysis application 472 that produces a mood-representation image (or mood-representative scene) based upon the aggregated data, according to the administrative settings. The mood and analysis application 472 can include a behavior algorithm, as will be described in greater detail below that computes the mood score. The behavior algorithm inputs the aggregated data and administrative settings to determine a mood score for the consumption, and output a graphical mood-representation image, corresponding to monitored consumption.

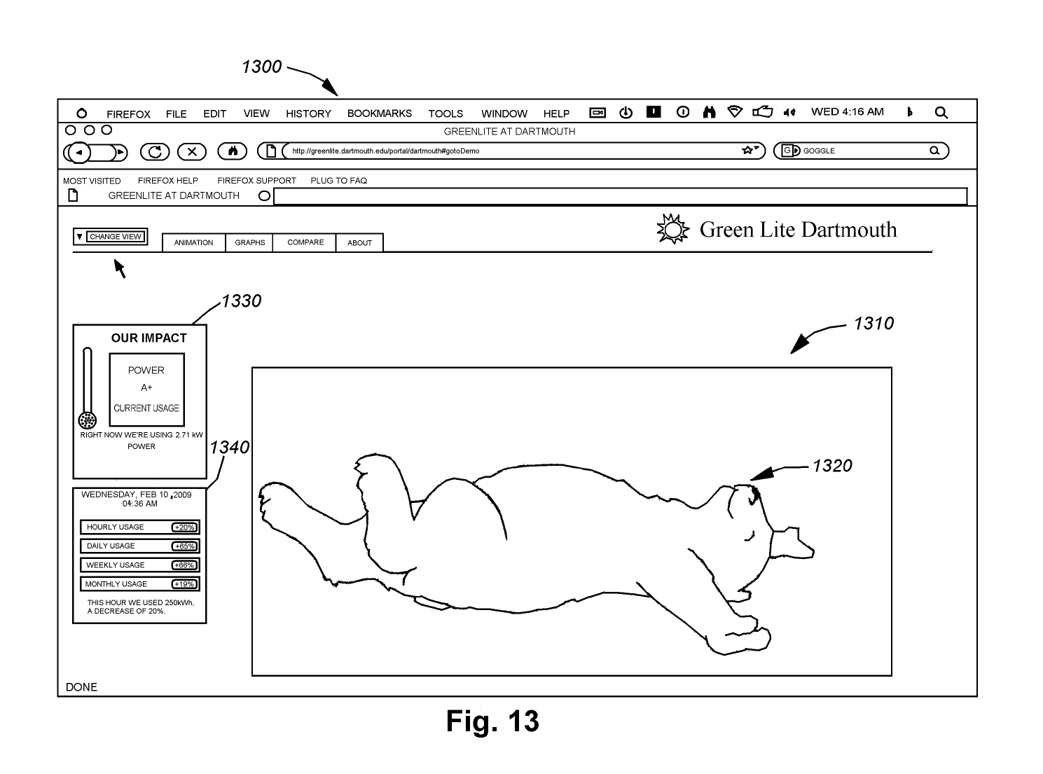

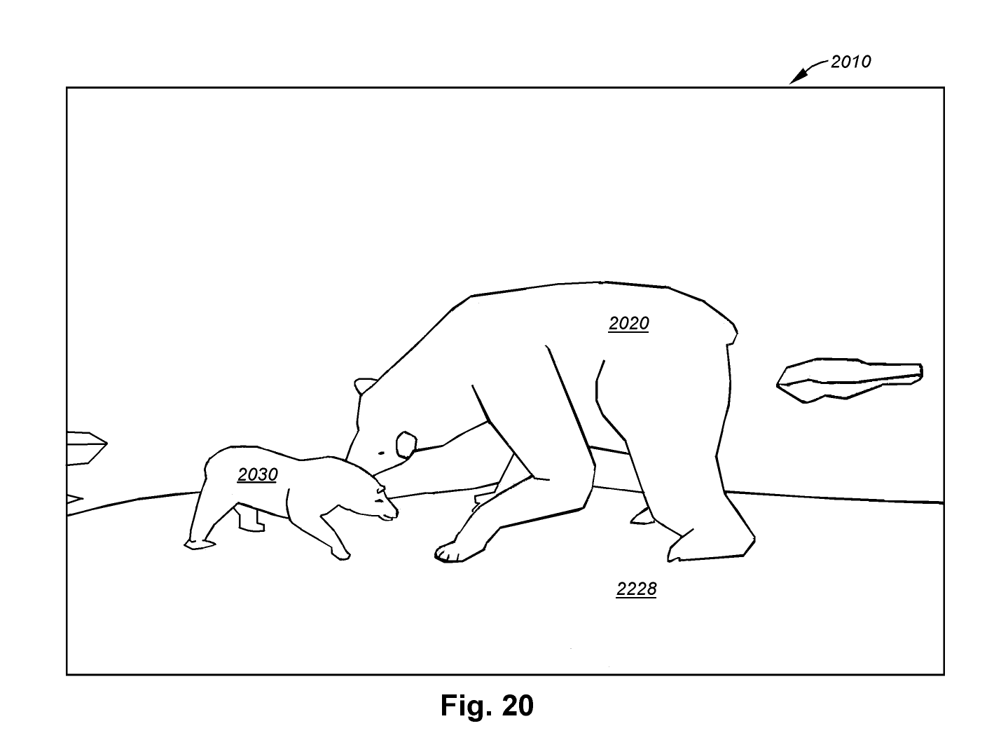

As shown in FIG. 4, the feedback, in the form of a mood-representation image, or another object that is constructed and arranged to evoke an emotional response from an interested individual, and is transmitted through the network to one of any number of available devices. The display can be a visual object or other image corresponding to the amount (metric) of resource consumption 480. This metric can be displayed as a mood-representative image based upon a mood score of the consumption (see FIGS. 13-18), or as a mood-representative scene (see FIGS. 20-30) incorporating a plurality of discrete image vectors to display an overall scene, and the interaction between the vectors, as will be described in greater detail below.

The object can be any mood-representation image or object that conveys consumption to an interested party. As discussed above, it can be a mood-representation image 480, but can also be represented on any device capable of performing standard networking techniques incorporating IP and/or device addresses for each device within the network. This can include a mobile device 481 (such as a wireless laptop, cellular telephone or Personal Digital Assistant—PDA), a website 482, a kiosk display 483, a miniature display 484 or any other type of display 485 that supports image viewing.

Reference is now made to FIG. 5, a block diagram showing the flow of data and other information between the functional and hardware elements within the consumption monitoring system. As shown, a plurality of meters (usage monitoring devices) 510, 520 and 530, each respectively send data to a Poller 540. The Poller submits requests for data to each meter to obtain relevant data for monitoring consumption of a resource.

In operation, the Poller 540 submits a request for data to each meter, via datastream 514 for meter 510, via datastream 524 for meter 520, and via datastream 534 for meter 530. The “meter” need not be a physical usage monitoring device in direct communication with the Poller, but can comprise a monitoring element that has accessible data stored thereon. The Poller can obtain data from a web service containing usage data for a plurality of devices (such as a web service containing usage data for a plurality of devices). The Poller can also communicate with a Modbus gateway that communicates with multiple usage monitoring elements (meters). The Poller can comprise any server and/or application running on a server that requests and receives consumption data. Upon receiving a request for data, each meter sends relevant data (meter 510 via datastream 512, meter 520 via datastream 522 and meter 530 via datastream 532) to the Poller 540. The usage data transmitted to the Poller 540 is used to monitor resource consumption, and is transmitted to a database 550. The database 550 can reside on a single computing device with the Poller and other server environment devices, or may alternatively remotely store data. As will be described in greater detail below, an administrator had discretion to determine when, and with what frequency, requests for data are sent to the meters 510, 520 and 530. For example, as will be described, this may occur every second, minute, hour, etc., or on a time-varying basis.

Note further, that the term “Poller” as used herein can also refer to processes running on individual monitoring devices or other intermediate components between monitoring devices and the server environment that effectively pus consumption data at desired times to the functional elements of the server environment. As such the server environment doe not literally poll the monitoring device(s), but rather receives offered data, which is appropriately addressed to the server environment by the monitoring devices and/or an intermediate component that collects and forwards consumption data. A variety of alternate arrangements to provide the needed consumption information from monitoring devices to the server environment can also be employed in accordance with ordinary skill.

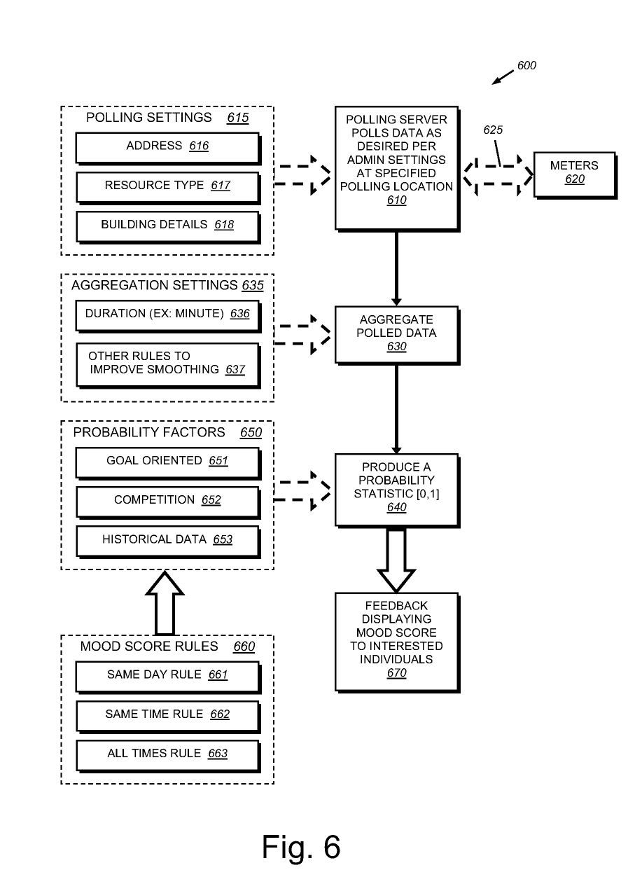

With further reference to FIG. 5, the usage data is transmitted to the database 550 from the Poller 540 via datastream 545. This usage data is then transmitted via datastream 555 to an aggregator 560 for aggregating the consumption data into a more streamlined set of data. This allows the system to compensate for unexpected peaks, to provide smoothing of the data, and additionally reduce the instances of usage data transmitted to the database that need to be stored. The aggregator 560 employs an aggregating application, based upon parameters specified by a system administrator. The aggregated data is transmitted to the database 550 via datastream 565. This aggregated data is then analyzed according to the behavior algorithm, as will be described in greater detail below, to produce a “mood score” for the particular monitored consumption. The mood score produced by the behavior algorithm 570 inputs the aggregated data via datastream 575. The aggregated data is put through a behavior algorithm to produce a mood score, as will be described in greater detail below in reference to FIG. 6 and the accompanying various mood-representative images of FIGS. 7-11.

As shown in FIG. 5, the behavior algorithm produces a mood score at 570, which is presented as feedback for each of a plurality of interested individuals 580, 582 and 584 via datastreams 581, 582 and 583, respectively. As will be described in greater detail with reference to the mood-representative images, the feedback for interested individuals 580, 582 and 584 can be presented in any of a number of display formats.

Reference is now made to FIG. 6, a flow chart detailing the procedure 600 by which a mood score display is presented to an interested individual. As shown, the procedure begins by polling data at step 610. The data polling of step 610 may be performed by a polling server, or polling application residing within a single server environment, as was described as server environment 430 of FIG. 4.

The procedure 600 can employ a plurality of polling settings 615, set by a system administrator, that determine the parameters for when the poller acquires data from the meters 620. The poller communicates with a plurality of meters 620 to obtain consumption data via communication 625. As described herein, the data can be gathered using TCP/IP, Modbus TCP, or other appropriate protocols recognized by those skilled in the art, and the meters can comprise any device having usage data stored thereon, or a web service having data stored therein for a plurality of devices. In one example, a Modbus gateway can be polled or otherwise provide data to the server environment in association with a plurality (e.g. 4-5) interconnected meters. Thus, as used herein the term “consumption device(s)” and/or “meter(s)” should be taken broadly to include intermediate devices or components that collect the data from a plurality of discrete metering/monitoring devices. The provision of one or more additional layers of data collecting devices can also be defined within these terms.

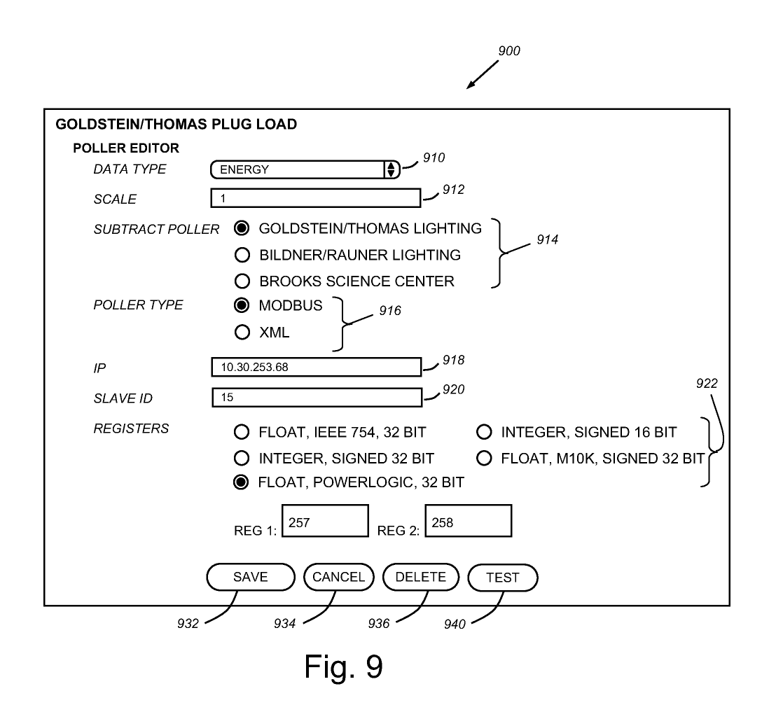

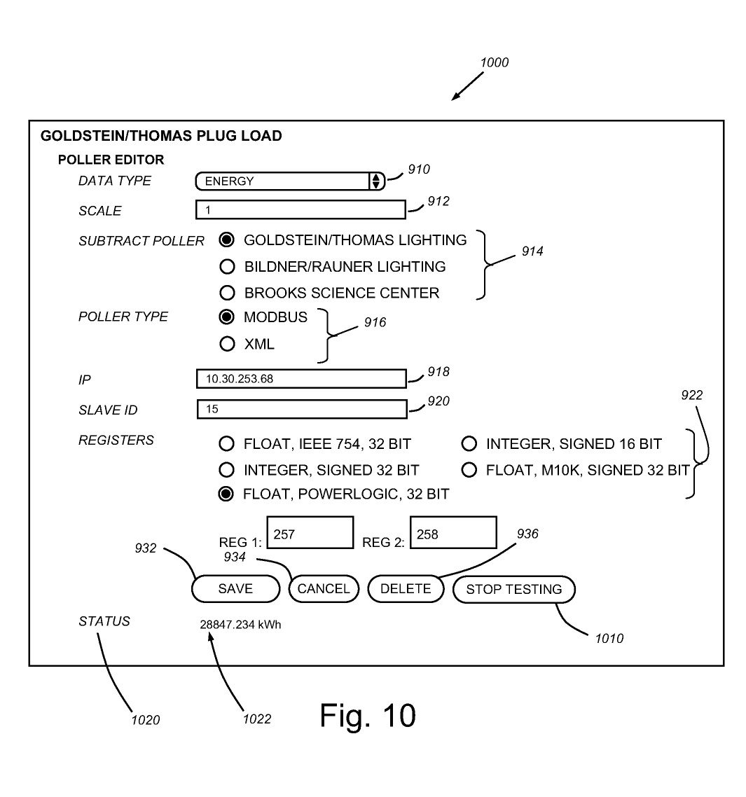

The polling settings 615 are set by a system administrator and can be provided through the use of a graphical user interface that inputs the administrator settings. These will be described in greater detail below with reference to FIGS. 7-11. These polling settings can include an address 616 of the location to be polled for data. The settings can specify the type of resource 617 that is to be monitored. Types of resources to be monitored for consumption can include (one or more) renewable and nonrenewable resource, including electricity, power, water and paper, among many others. Note that in alternate embodiments, other monitorable individual and community behaviors can be substituted (described further below), and thus the terms “consumption” and “resource” can be take broadly to include wasteful spending, trash creation, recycling participation and other activities that can be defined by levels of behavior and goals. The polling settings 615 can also include further details about the building 618, as will be described in greater detail with reference to FIGS. 9 and 10. The settings can further define polling/data gathering criteria—as an example: subtract the second floor usage reading from the reading on the first floor, and then use the result as the first floor usage. In this example, the building can be wired in such a way that an individual meter is monitoring more than one floor necessitating the subtraction.

The procedure then aggregates the polled data at step 630 to produce a set of aggregated data. The aggregation settings 635 can also be set by a system administrator to determine the aggregation parameters. For example, an administrator of the system can set a particular duration 636 over which a particular set of polled data are aggregated. This duration may be set per minute, for example, such that all data gathered for one minute is aggregated to provide an aggregated data value. The system administrator can also select other rules to improve the smoothing 637 of the consumption data.

The aggregated data is input to the behavior algorithm, as described herein, to produce a probability statistic for the aggregated data at procedure step 640. The system administrator can set a plurality of probability factors 650 to determine the probability based on the behavior algorithm.

The probability statistic used to represent the mood score is determined based on the type of probability to be analyzed (651, 652 or 653) as well as the particular mood score rules 660 specified by the system administrator. The probability factors 650 determine one of the means by which the amount of resource consumption is conveyed to an interested individual.

One of the procedures used to determine the probability statistic can be a goal oriented procedure 651 in which the system administrator sets a particular goal for consumption amount. According to this procedure, the consumption goal is then compared to the actual goal, based on the mood score rules 660, to determine the probability statistic. This is then translated into a mood-representative image and/or scene, as will be described in greater detail hereinafter, based on administrator settings. The mood score rules 660 determine, based upon the instances of consumption data available for analysis and computation.

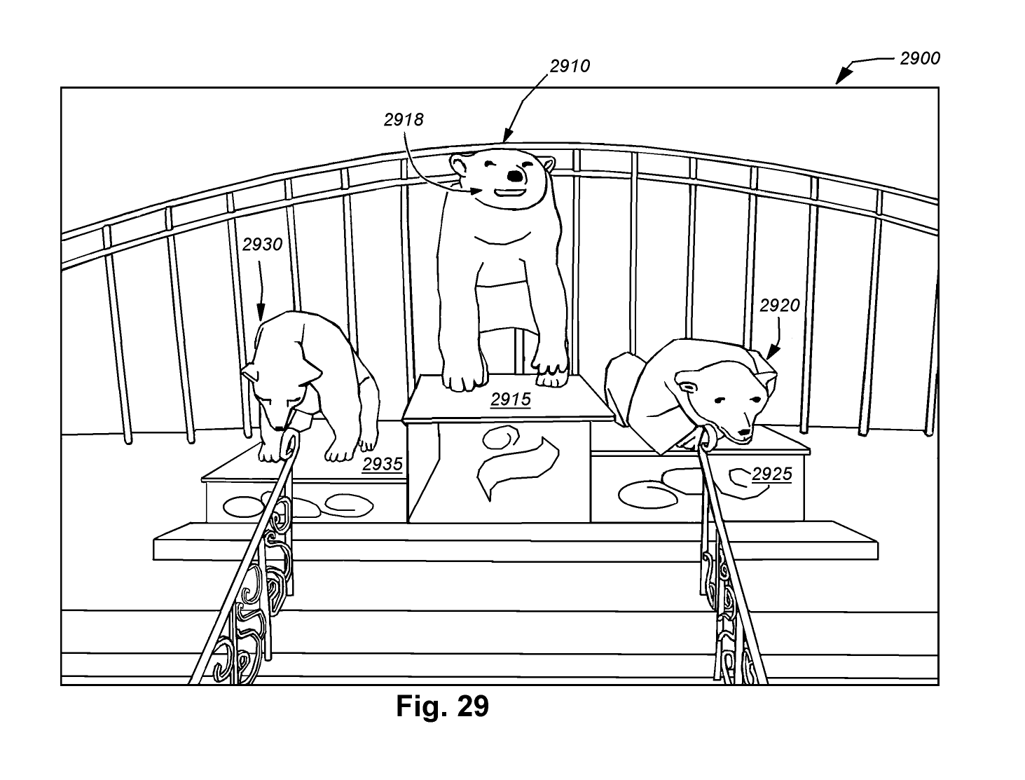

The probability statistic can also be produced according to a competition-based procedure 652 in which the mood-representative image and/or scene is provided to an interested individual based upon comparison to data of another, “competitor”, polling location. An example of this type of display is found in FIG. 29 and its accompanying description. The mood representation provided to an interested party is displayed based upon the mood score rules 660 specified by a system administrator. These mood score rules determine the comparison of individual instances of consumption data to appropriately calculate the probability statistic based upon the instances of consumption data.

The probability statistic can further be produced according to a purely historical data procedure 653. In this manner, a system administrator determines mood score rules 660 that set the comparative parameters for determining the probability statistic. For example, to compare based upon historical data, to compare data from the same day, the same day rule 661 is executed. This determines the data to be compared for producing the probability statistic. To compare, for example, based upon the same time, the same time rule 662 can be executed to compare accordingly. To compare historical data irrelevant of the day or time (for all times) to undertake a purely historical analysis, the all times rule 663 is executed. Accordingly, the mood score probability statistic can be determined by comparing the consumption data. As described below, mood score can also be effected by other factors—particularly consumption goals. In this manner, a score that is historically good may be depicted as less than acceptable, due to goals for reduced consumption.

As will be described in greater detail hereinafter, the feedback displaying the mood score probability statistic as a mood-representative image and/or scene is conveyed to interested individuals at procedure step 670. This display provides an interested individual with a mood-representative image and/or mood-representative scene to convey consumption to an interested individual.

It should be clear that the computation of a mood score can occur in a variety of manners using various mathematical and statistical equations that should be clear to those of ordinary skill. In a generalized embodiment, the various parameters and factors of the computation are given predetermined weightings so as to generate a desired score that is employed to drive the display. Illustratively, administrators specify rules to define the relevant historical data related to consumption. For example, an administrator can specify that data from the same time (the hour centered on the current time), same day, gathered over the previous ‘x’ number of weeks as relevant historical data. Thus, the administrator can hold constant the day and the time of day. Alternatively, the administrator can hold constant the time of day, and determine the relevant data to be data obtained at the same time over the past several, ‘x’ number of days, as specified by the administrator. The administrator can also decide that only data over the past ‘x’ number of hours is relevant, and accordingly neither the day nor the time is held constant. The system thereby computes a probability statistic using the current power consumption with respect to the relevant data, as determined by the system administrator, as described hereinabove. The statistic is computed (see 640 of FIG. 6) and scaled to be on the interval of [0,1]. A score of “0” generally indicates that the current consumption is very good (better than any observation in the relevant historical data). A score of “0.5” indicates the consumption is equivalent to the median value, and the expected average, of the relevant historical data. A score of “1” however, indicates that the current usage exceeds all relevant historical observations. Other consumption probabilities are represented as a score of 0 to 1 accordingly.

Reference is now made to FIGS. 7-11, showing diagrams of graphical user interface displays for managing the polling settings, aggregation settings, mood score rules, and other settings in an embodiment of the system. These settings determine the precise display for conveying the mood-representative image and/or scene to an interested individual.

FIG. 7 shows a diagram of a graphical user interface display that shows a node management screen 700 according to an illustrative embodiment. The Node Manager 710 allows a system administrator to manage an existing node 720 or to create a new node 730. The existing nodes 720 each have an edit button 722, 724, that can be selected to make edits to any existing nodes 720. To create a new node, a name for the new node can be typed or otherwise entered into new node name box 732, and can be created by selecting the “create” button 734, or to change the name, it can be cleared to type in another node name.

A “node” as used herein is representative of any polling location, as specified by the system administrator, including an individual poller at a single location, as well as an overall polling system representative of multiple polling locations. As shown and described in FIG. 6, the polling settings 615 determine the particular node that is to be analyzed. A node can represent a particular building, a floor within the building, a single room, or even down to each individual's average (or actual) consumption as discussed below.

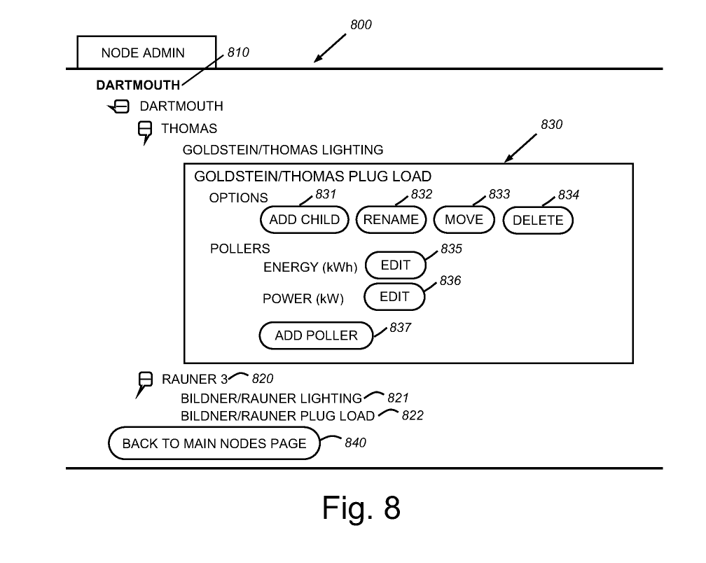

To edit an existing node, such as the exemplary “Dartmouth” node, the edit button 722 can be selected, which directs a user to a node editing screen such as that displayed in FIG. 8. Showing the details for this particular node, a graphical user interface display screen 800 shows the details for the exemplary “Goldstein/Thomas Plug” load (i.e. an user (dormitory, for example) named Goldstein and Thomas) of the Dartmouth node 810. The Goldstein/Thomas Plug load is one polling location within the Dartmouth node 810. As previously described, the consumption monitoring system employs a polling application to poll data at a specified location. The system administrator can specify the location to poll data over the entire Dartmouth node, or merely at a single polling location, such as the Goldstein/Thomas plug load display 830. Note than a node can be virtual. For example, a number of meters associated with a given building (floors, wings, etc) can be combined to define a single “building node,” notwithstanding the absence of a single building-wide meter. Likewise, regions of a campus can be defined by a node, by combining various virtual building nodes. Consumption values for the individual constituents of large combined nodes can also be stored for subsequent use. For example, an average value for each individual's consumption within a given floor building node can be computed and stored by dividing node consumption by number of individuals within the node.

The display 830 provides a system administrator with a series of Options, including “Add Child” 831, “Rename” 832, “Move” 833 and “Delete” 834. These options allow a user to specify the particular Node. The system administrator can also specify the types of Pollers (i.e. the type of resource consumption to be analyzed). Each can be edited to change the consumption monitoring. For example, the Energy poller can be changed by selecting the Edit button 835, and likewise, the Power poller can be changed by selecting the edit button 836. A system administrator is also presented the option of defining another polling location from which to obtain data, by selecting the “Add Poller” button 837. The system administrator can also return back to the main nodes page, to modify and edit other node settings, by selecting the “Back to Main Nodes Page” button 840.

A system administrator desiring to edit a particular Poller can simply select, for example, the Edit button 835, which directs a system administrator to a graphical user interface screen display, such as that shown in FIG. 9. Detailing a particular Poller Editor screen display 900 of a particular Node within the Dartmouth node, a system administrator is presented with a plurality of options for determining the data polling parameters. These are specified in FIG. 6 as the “Polling Settings”. FIG. 9 in only to show by way of example the particular Polling Settings that can be selected for specifying the polling data location and data acquisition.

As shown in FIG. 9, Data type drop-down box 910 provides a system administrator with a series of options for selecting the data type. As shown, “Energy” has been selected for this particular Poller. Also note, the system administrator can set a Scale by typing into the box 912. The system administrator in this instance as selected 1, which is a maximum value on a probabilistic scale from 0 to 1. Any intermediate value is represented as an appropriate decimal.

A subtract poller can be selected from the group 914 to further define the particular mechanism for polling data. As discussed in the example above, the subtract poller can be employed to subtract the polled data of the second floor from that of the first floor to determine the first floor polled data. A system administrator can specify the poller type 916 by specifying either Modbus or XML. While Modbus and XML are displayed, any appropriate polling type can be employed to obtain the polling data. The system administrator can enter an IP address for the particular Poller/polling location into entry box 918, as well as the Slave ID into text entry box 920. The Modbus data Registers 922, according to an illustrative embodiment, can also be specified to determine the appropriate registers (when using Modbus TCP) from which to obtain consumption data for a particular polling location. Note that for an XML-type poller, the administrator can define the names of the XML nodes which contain a particular value. In an embodiment that can measure printer paper consumption (described further below), the administrator can define names of XML nodes which contain a particular value for use with XML pollers. By way of example, for a printer data xml feed that is the following:

```
<xml>
  <total_pages>10504</total_pages>
  <last_hour>145</last_hour>
  <last_update>4/14/2009 03:34:14</last_update>
</xml>
```

The administrator can specify the url to obtain the xml at (for example, http://printerstatus.dartmouth/edu) and specify that the “total pages” value can be obtained by traversing “xml”, “total_pages”. In the illustrative embodiment period-separated notation can be used to specify node paths, so the administrator provides the value “xml.total_pages”.

The user then has the option to save any changes by selecting the “save” button 932, or has the option to cancel any changes by selecting the button 934. The system administrator can also delete a particular poller by selecting the “delete” button 936. To perform a test of the poller, i.e. to obtain consumption data from the poller to ensure the settings are correct, a user may select the “Test” button 940.

The system administrator is then directed to a Poller Editor screen display 1000 similar to that of FIG. 9, however the poller editor includes a status 1020 of the polling location. To stop the testing, a user may simply select the “Stop Testing” button 1010. The Status 1020 is displayed as a particular value 1022 representative of the current energy consumption based upon data retrieved from the polling location.

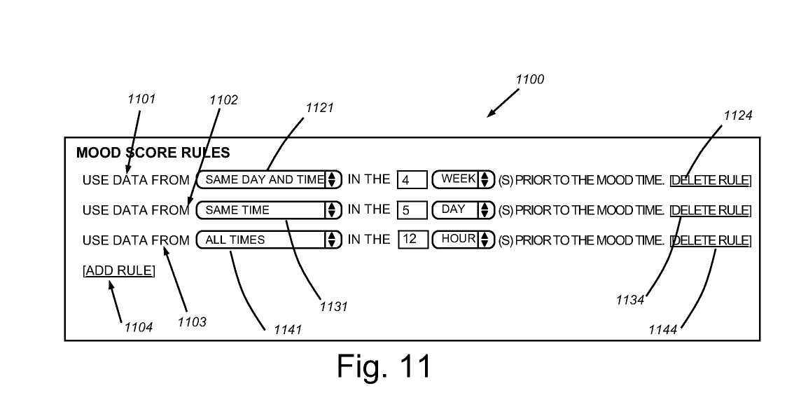

As previously discussed, a system administrator can specify a set of one or more mood score rules that determine the appropriate comparison for data analysis. These are demonstrated as mood score rules 660 of FIG. 6. Referring now to FIG. 11, a Mood Score Rules display 1100 is provided. There are three mood score rules specified by the system administrator, including rules 1101, 1102, and 1103. This set of exemplary mood score rules is for a purely historical data analysis based upon comparing consumption at the time the mood is scored, with consumption at a same day and time within the month. The system administrator can add another rule by selecting the “Add rule” link 1104.

For example, rule 1101 specifies the data to be used for analysis, based on having data consumption for at least one month available. As shown, the system uses data from the same day and time, as selected by the drop-down box 1121, in the 4 weeks prior to the mood time. In this manner, for example, the system compares data obtained at a particular day and time with data compared at the same day and time for each day within that month. Accordingly, the data is correctly compared to historical data in determining consumption. For a purely historical type of data analysis, data from the same day and time is compared to thereby determine the consumption of a resource. This rule can easily be deleted by selecting the “delete rule” link 1124.

However, if a month is not available, rule 1102 describes to use data from the Same time (as selected from drop-down box 1131). If there is at least 5 days of data available, the system administrator specifies that data from the same time will be used to determine the mood score. Accordingly, if only one week of data is available, and the poller is determining data consumption for purposes of producing a mood score, the system administrator specifies that the comparison will be between other data from the same time. This rule can easily be deleted by selecting the “Delete Rule” link 1134.

Rule 1103 specifies that if there is not 5 days worth of data available, for example if only 12 hours of data is available, to compare the usage data obtained to all times, as selected by the drop down box 1141. In this manner, data is compared to all other data, regardless of the day and/or time. This allows the system to operate, even when only capable of analyzing several hours of data. In this manner, an interested individual has feedback representative of resource consumption within hours, if not sooner.

The mood rules set forth in FIG. 11 are representative of exemplary rules that can be used to implement the consumption analysis described herein. Note the system lists each factor, but does not weight each rule differently based on a set of weighting parameters. However, the system administrator can specify a weight assigned to each rule to determine the polling settings appropriately.

For example, the system allows a user to specify the display to the interested individual will be 50% based upon a historical procedure, and the other 50% based upon a goal-oriented procedure, using administrator-set consumption goals that may require lower consumption (by, for example an absolute value or a percentage) relative to historical consumption values. In this manner, additional factors are used to produce, and further customize, the mood-representative image and/or scene.

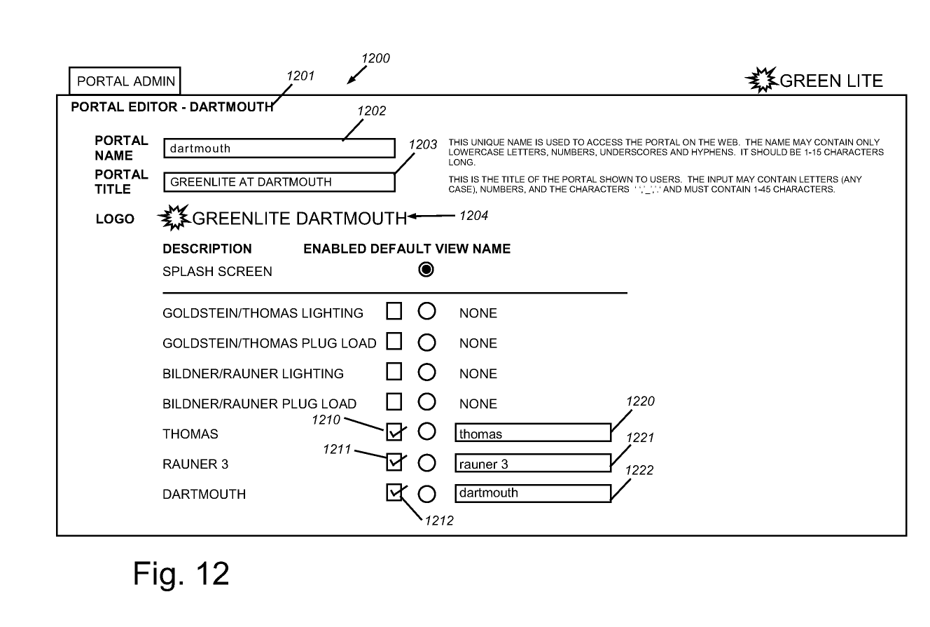

Reference is now made to FIG. 12, showing a diagram of a graphical user interface display showing a Portal Editor screen display 1200 according to an illustrative embodiment. The portal editor display 1200 allows a system administrator to specify the details for a particular portal. There are a series of steps through which a system administrator navigates (not shown), that brings them to the display of FIG. 12. This screen shows the particular details for the “Dartmouth” poll 1201. The Portal Name can be changed by typing a new name into the text entry box 1202. Also, the Title of the Portal can be edited by typing into the text entry box 1203.

The display 1200 shows the logo 1204 representative of the particular portal. A system administrator selects a particular check box for each node within a portal, to thereby enable the particular node. For example, checking box 1210 enables the Thomas node, box 1211 enables the Rauner 3 node, and box 1213 enables the Dartmouth node. A “view name” for each of the nodes can also be specified by typing into the respective text entry boxes 1220, 1221 and 1223.

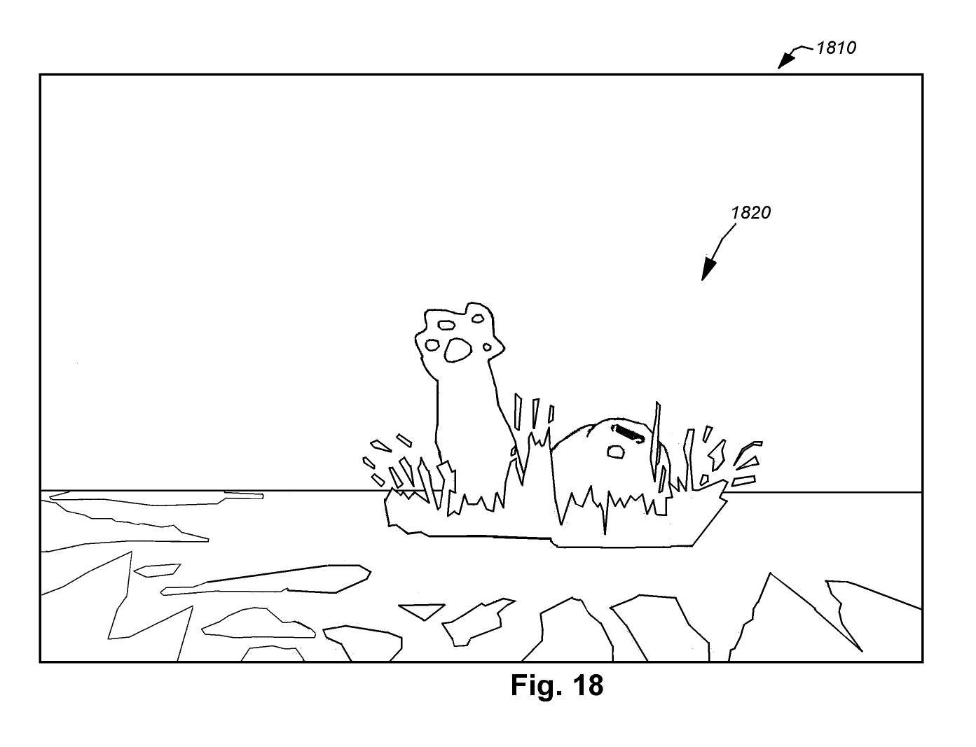

Referring now to the mood-representative images produced by the consumption monitoring system described herein, FIGS. 13-18 represent a series of mood scores representative of various degrees of resource consumption. FIGS. 13-18 each represent one of at least six discrete states of consumption and associated mood, the “first” state representing a highly desirable (i.e. low) state of consumption. In this “first” state of consumption shown in FIG. 13, the bear is depicted as being in a great mood, representative of the environment given the amount of resource consumption. However, in the “sixth” state of consumption shown in FIG. 18, the bear is nearly drowning in the water after slowly falling through the ice as the amount of resource consumption increased. While this shows only six of the possible states of consumption, effectively an infinite number of states of consumption can exist, each represented by a particular image and/or scene environment. The number of discrete states that can be displayed can be set by a system administrator and are thus highly variable. Likewise, states can be infinitely variable. The consumption factors that influence changes in states are also highly variable as described above.

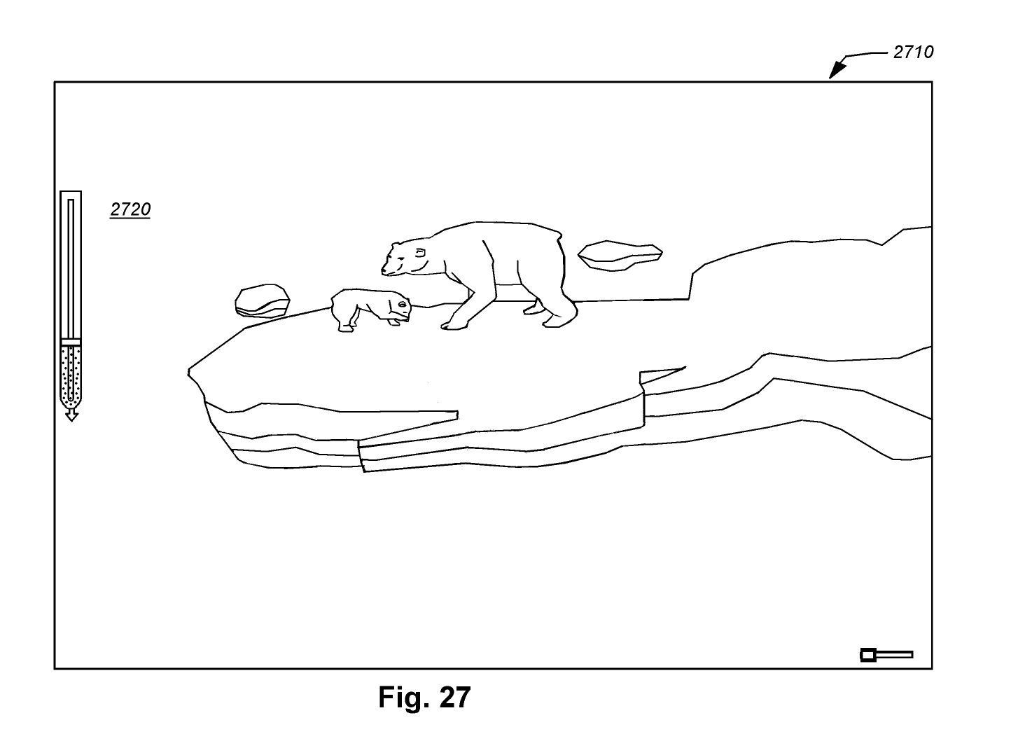

The graphical content employed in the displays herein can be generated using commercially available graphics software. For example, Flash®, available from Adobe Systems, Inc., Maya®, available from Autodesk, Inc. of San Rafael, Calif. and/or the Unity™ development tool available from Unity Technologies ApS of Denmark, are the exemplary software applications that allow creation of two-dimensional and three-dimensional displays in accordance with this system and method. The various images and animations that represent the desired emotion-inducing mood states can be constructed using well-known graphical design techniques, carried out by those skilled in computer graphic design. The system can support an arbitrary number of artist-created content to display mood, and such mood can be based on either long-term or short-term consumption behaviors, as described herein. The illustrative mood-influencing image is provided as an animation, using scripts that allow the animation of the image to be driven (changed/varied to display differing mood states) based upon the associated mood score. Where the image is obtained by user interaction (e.g. opening a browser, starting a screen saver or touching a touch screen), the server environment is queried for the current mood score relative to the user and/or display device. As described below, when a user touches a touch screen, the system can display text and other images in response to this interaction (See FIG. 27A, below). The system can also send events (i.e. push content) to the display arbitrarily. Such content can include a graph, and animation or text, among other displayable types of content. Hence the front-end display viewed by individuals can be drive either by the back-end server environment (based upon preprogrammed criteria) or by front-end user interaction (or both). In general, the images presented are adapted to elicit or evoke an emotional response in the viewing interested individual, while representing real data with respect to consumption. The design of the images is expressly contemplated to encourage the interested individual to change behavior and to change associated social norms. More generally, the varying image provides viewing individuals with a meaningful graphical story centered around their and the community's short-term and/or long-term consumption patterns.

FIG. 13 is a diagram of a graphical user interface showing a mood-representation image, in which the mood of a polar bear character is used to convey a first state of consumption. This interface screen 1300 includes a mood display 1310 showing a polar bear character image 1320. As shown, the polar bear is very content in his environment, further emphasized by the low power usage shown in usage box 1330. There is also provided an interface box 1340 which allows an interested individual to obtain additional data regarding the resource consumption. The image display 1320 is desirable for conveying the mood score to interested individuals, while the further data links of 1340 provide an interested individual with the further, technical and raw data for further analysis, as desired.

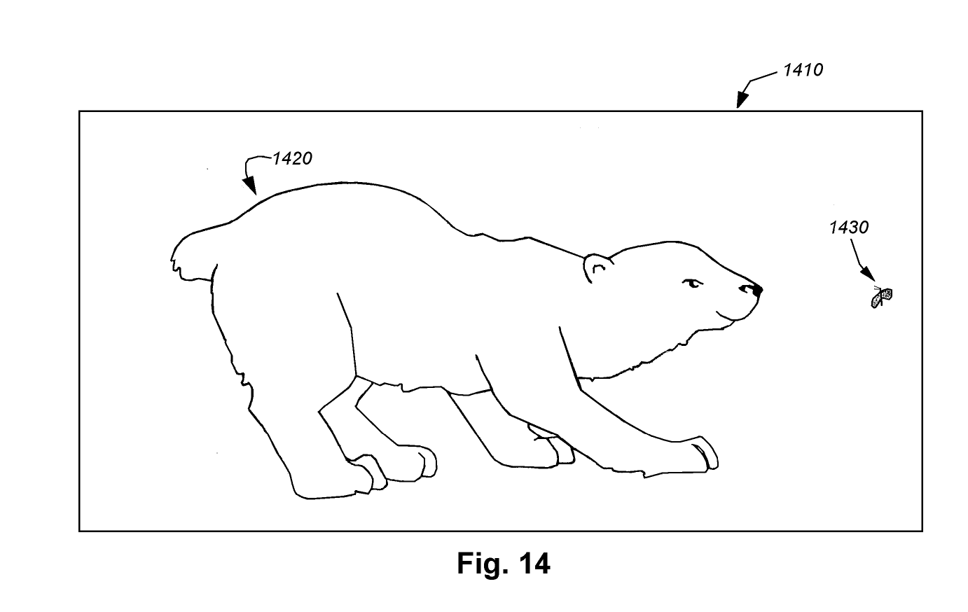

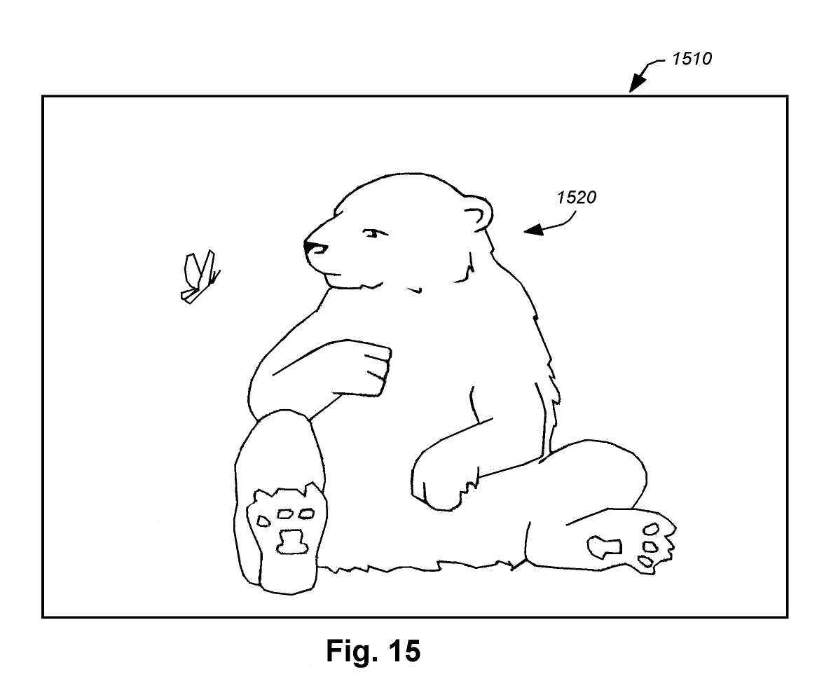

FIG. 14 shows the graphical display 1410 showing a polar bear character image 1420. This represents a second stage of consumption, in which the power consumption has increased slightly, and the polar bear is beginning to play with the butterfly 1430. The consumption has begun to increase, and thus the environment for the polar bear is accordingly changed to a less-stable type of environment. FIG. 15 is a graphical display 1510 showing a polar bear character 1520, according to third stage of consumption. The mood score represented by the mood-representative image 1510 shows the bear character 1520 becoming increasingly distracted in his environment, indicating a change in consumption and distress in the environment.

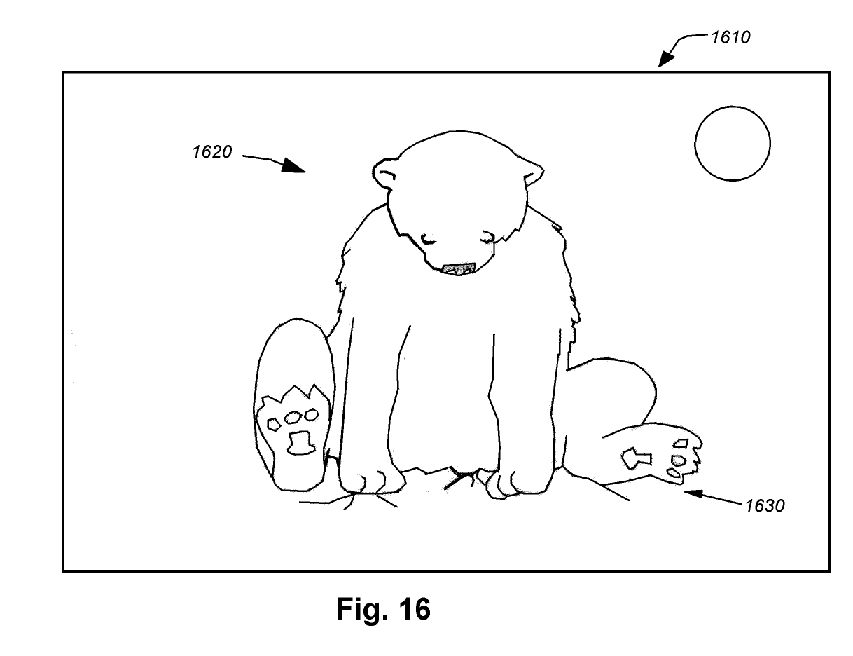

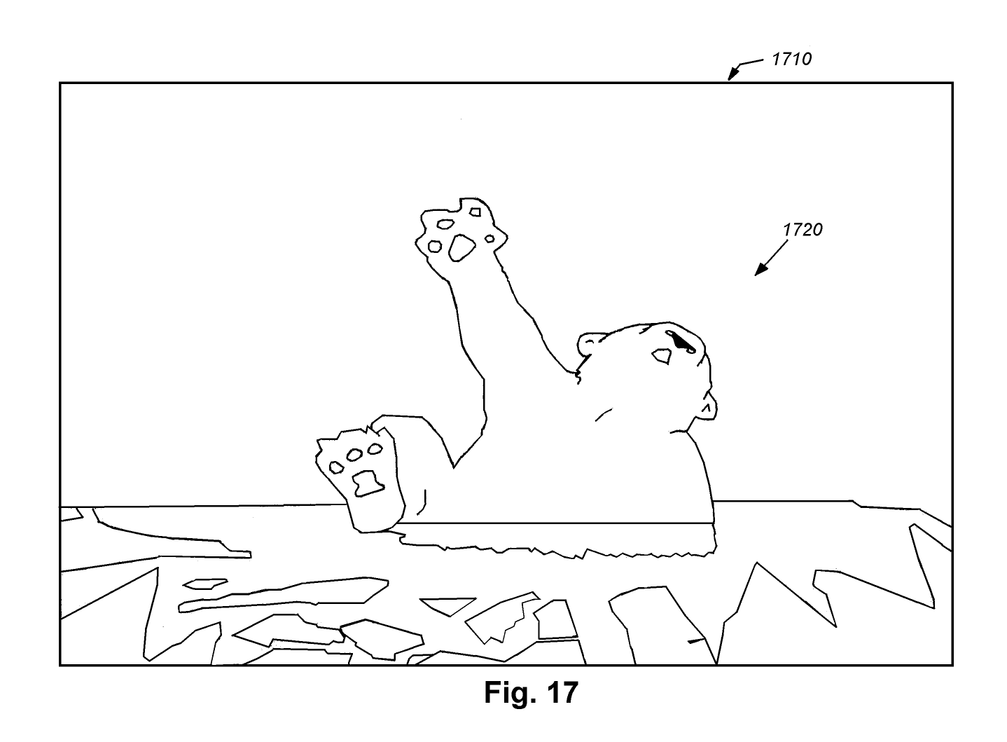

FIG. 16 is a graphical display 1610 showing a polar bear character 1620, representative of the mood score for a fourth stage of consumption. Note the polar bear character 1620 is becoming more distressed in his environment, indicative of a further increased consumption in resources. The ice beneath the polar bear is beginning to crack at 1630, further showing distress in the environment. As shown in FIG. 17, as the consumption increases to a fifth stage, indicating heightened consumption of resources. FIG. 17 shows a graphical display 1710 in which the polar bear character 1720 is severely distressed in her environment, and beginning to sink through the ice. The environment of the bear is designed to represent the stage of consumption to the interested individual, to motivate them to reduce consumption. As the consumption continues to increase to a sixth stage of consumption, shown in FIG. 18, the graphical screen display 1810 shows a polar bear character 1820 nearly completely sinking into the water, in an incredibly distressed environment.

As the resource consumption increases and decreases, one of the series of graphical screen displays (shown in FIGS. 13-18) is displayed to an interested individual. This image represents to an interested individual the effect of their consumption on the environment, in an emotionally meaningful way.

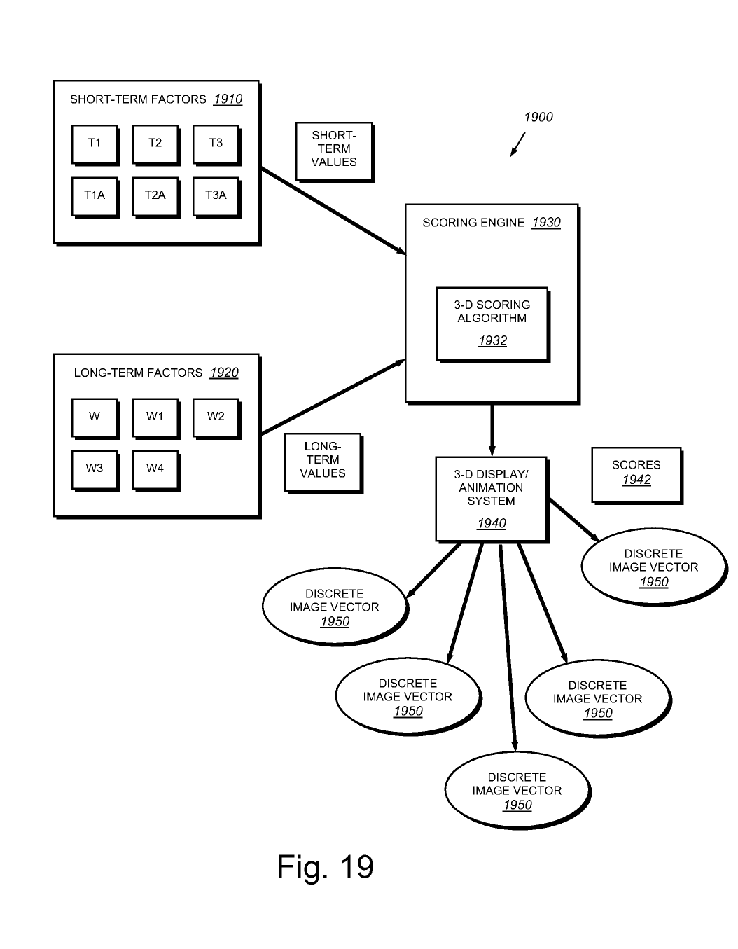

Reference is now made to FIG. 19, detailing a block diagram 1900 showing the interaction between a plurality of exemplary factors 1910, 1920 influencing the mood scoring, particularly in an illustrative three-dimensional environmental display system, in which various factors and scores are used to vary multiple aspects of a given display. In an example, the factors 1910 can include consumption values for computing short-term mood score Illustratively, the short-term mood score for a given node can be computed by comparing consumption values T1, T2, T3 to previous month's values T1A, T2A, T3A, respectively, holding constant same time and same day. These values T1, T2, T3, etc., can be the 15-second rolling average of short term mood score, 30-second rolling average of short term mood score, 60-second rolling average of short term mood score, etc.

An exemplary approach for deriving a node's long-term mood score (for use with any display contemplated herein) can be computed by comparing total resource usage/consumption for the present week W versus the four previous weeks W1, W2, W3, W4. Alternatively, or in addition, a long-term mood score can be computed using daily or monthly changes in resource consumption.

Another score that can be computed for use with any display herein is a competitive score. By way of example, a number is computed by taking each nodes (for example, a dormitory floor's) per-person weekly (or daily, monthly) consumption, and then computing a percentile rank. This score can be mapped into a progress meter or otherwise displayed as the outcome of a competition as described below.

All scores are processed from their sources by the scoring engine, which is part of the server environment, using the 3D scoring algorithm 1932 that performs the comparisons, and can apply various weightings and goals to modify the scores. The 3D display/animation system has access to all computed scores 1942, and maps these scores onto the display's current environment (for example, the algorithm, or another function of the server environment, can define the level of “smog” in the environment to be a function of 75% of the long term score and 25% of the competitive score). The various scores can be used to drive discrete, individually variable vectors of the current image. These can include the state of the ice, whether the bear and its cub are separate or together, the facial expression of each bear, the background environment and a variety of other content. In an illustrative embodiment, the 30-second rolling average of the short-term score can be mapped by the animation system 1940 onto bear's mood (say whether he was smiling or not, and to what degree). As part of the content delivered by the display (described further below), the system can illustratively produce dialog based on a rule such as: “if viewer is in 1^{st} place in consumption competition, provide message from bear stating Good Job, You're Winning! every 500 seconds.”

The three-dimensional mood-representative scene, incorporating both long-term and short-term factors, to create an overall environmental mood, indicative of consumption, is shown in FIGS. 20-25. FIG. 20 is a diagram of a three-dimensional graphical user interface display showing a mood-representation scene, using a variable image of an adult bear and her cub, to display a multi-factor consumption environment. The environment is created according to the discrete image vectors, each representative of a different factor, to create an overall scene representative of overall consumption, as described with reference to FIG. 19.

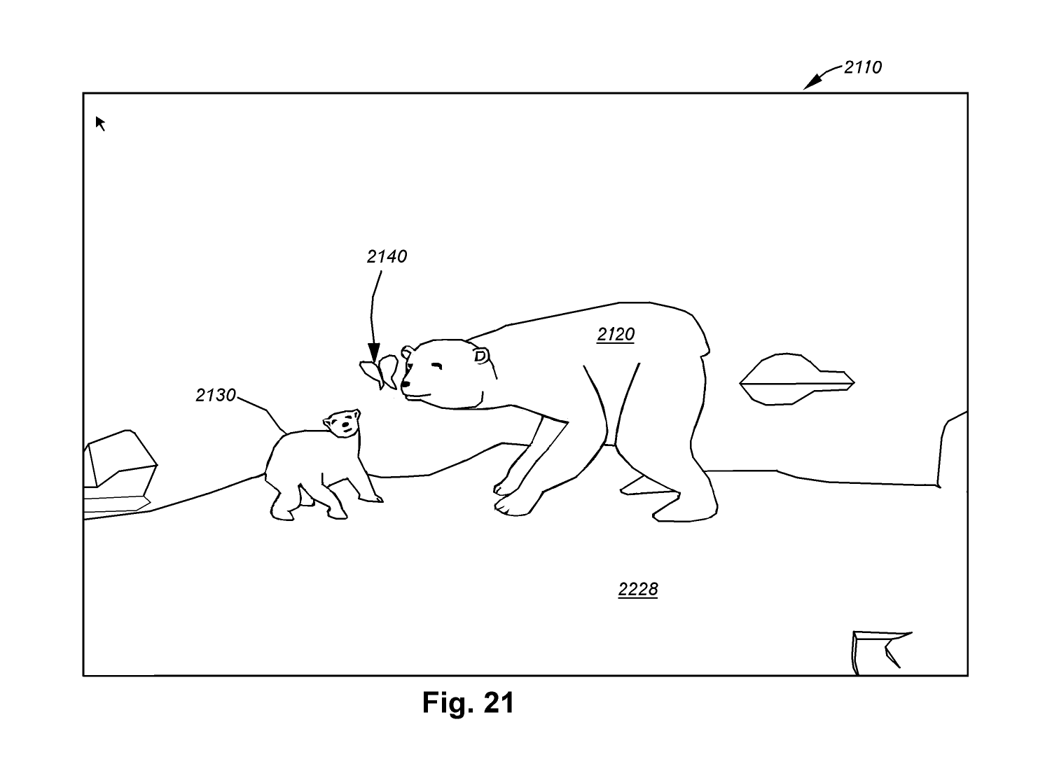

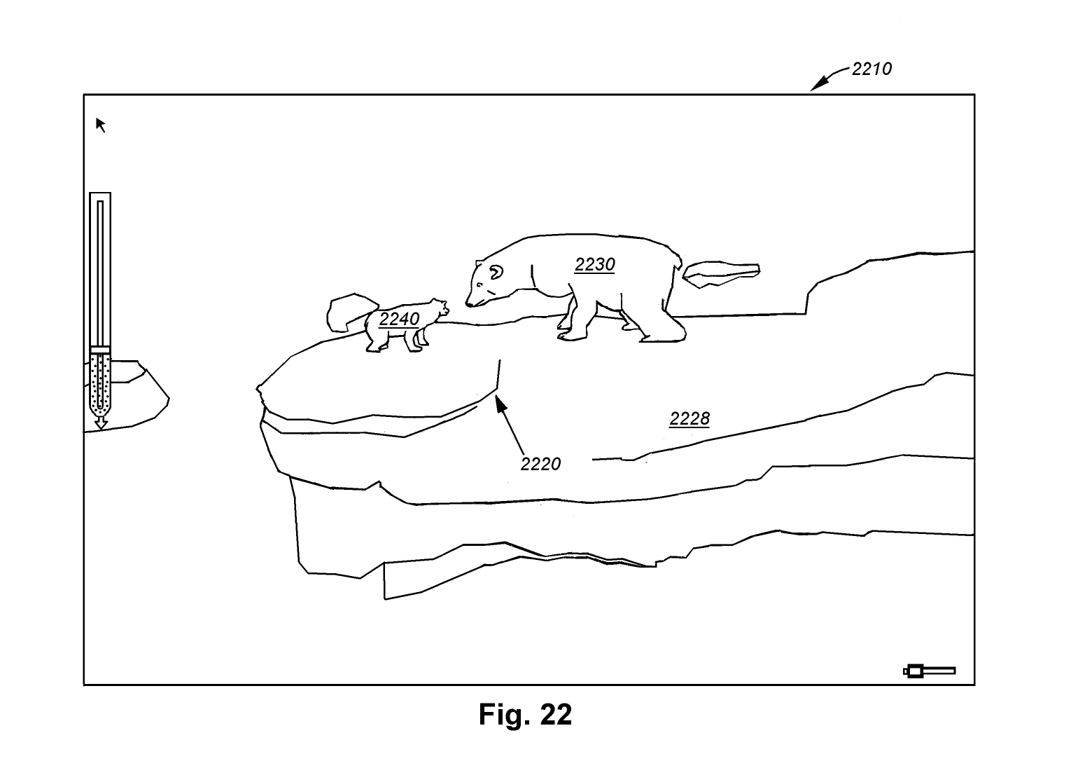

As shown in FIG. 20, the display 2010 shows that the resource consumption is relatively low, as the adult mother polar bear 2020 and the baby cub 2030 are nuzzling together, indicating a good mood score. Note they are not distracted by any external environmental factors and are happily playing together, in an enjoyable environment. As the resource consumption becomes worse, the bears become distracted and their environment becomes more and more distressed, as shown in FIG. 21. The three-dimensional display 2110 shows the adult bear 2120 and the baby cub bear 2130 beginning to play with the butterfly 2140, as their environment becomes distressed and the bears become distracted. As the resource consumption continues to increase, the bears 2120 and 2130 continue to become increasingly distressed. FIG. 22 shows a three-dimensional display 2210 in which another factor has changed in the consumption environment, causing the environment to become in distress as a crack 2220 forms on the ice of an ice flow 2228 located between the adult mother bear 2230 and the baby bear cub 2240 on the ice 2228. Note the environment of the baby cub and the adult mother polar bear is becoming increasingly distressed as the consumption of resources increases.

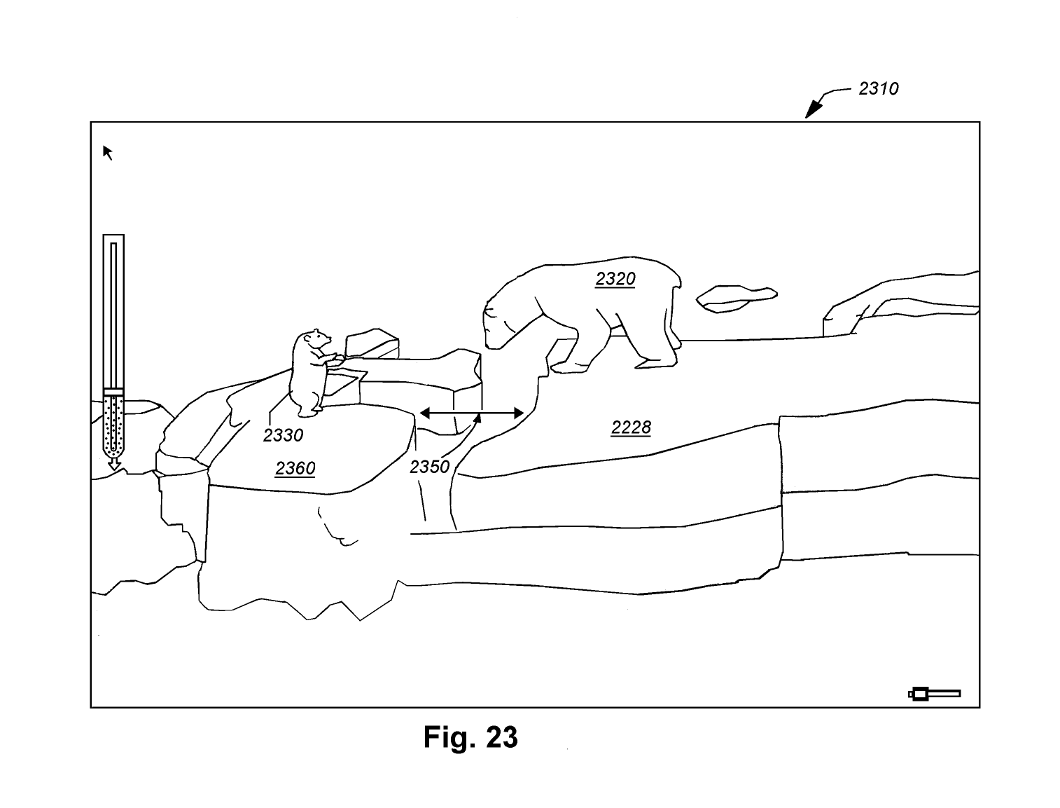

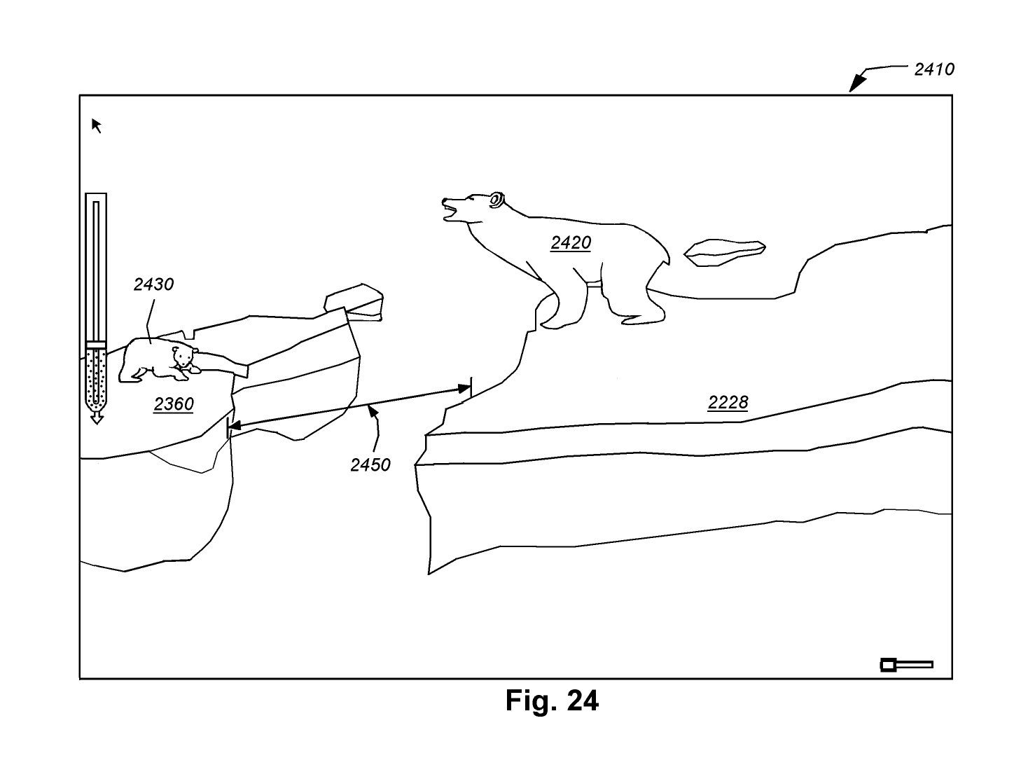

Another factor, as shown in FIG. 19, causes the mood score to be decreased even further, indicating a further stage of consumption, represented to an interested party such as the display 2310 of FIG. 23. The ice is continuing to crack and the baby cub 2330 is drifting further and further away form the adult mother cub 2320 on broken off iceberg 2360 (symbolizing melting ice due to global warming). As the consumption continues to increase, the proximity of the bears continues to decrease as the distance 2350 between the bears continues to grow larger. This distressed environment is a direct relationship to the harm caused to the interested individual's actual environment due to their overconsumption. In FIG. 24, the environment of display 2410 shows the adult mother bear 2420 beginning to cry in despair as the environment becomes increasingly worse. The distance between the mother bear 2420 and the baby cub bear 2430 has increasingly grown, as shown by the gap 2450 that now exists between the mother bear 2420 and the baby bear 2430. This demonstrates an overconsumption in power, particularly compared to other types of usage as defined by the system administrator.

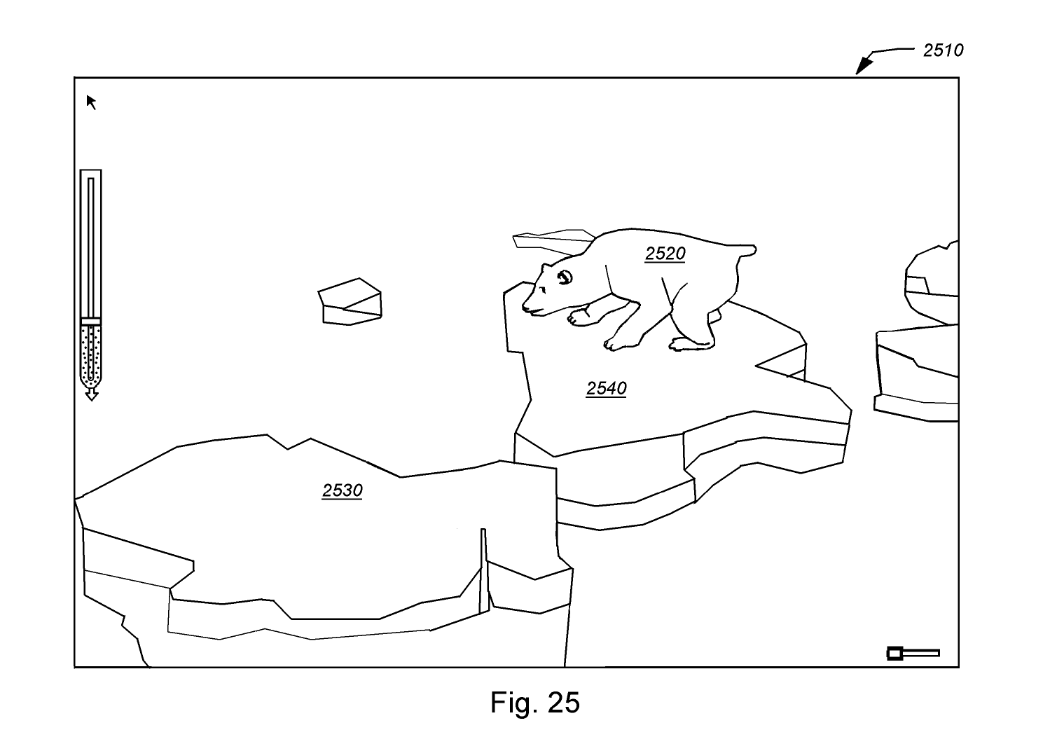

Still further overconsumption is demonstrated by the highly distressed display 2510 of FIG. 25. As shown, the adult polar bear 2520 is now beginning to suffer distress herself, as her iceberg begins to breakdown itself into smaller pieces 2530 and 2540. Note the adult polar bear 2520 is now forced to survive on a small iceberg 2540, as her environment becomes increasingly distressed. Again, as noted with respect to the mood-representative images, the mood-representative scenes can vary from a low consumption environment to a high consumption environment, with scenes of varying degrees in between, in response to the resource consumption.

While the bears are generally described herein as being in close proximity and thus in a good mood, when the resource consumption is low, the proximity of bears, their individual facial expressions, and several other factors are changed according to the mood score produced by the polled data. For example, two bears can be close together, but they could be sad for other combinations of factors, thereby changing the mood-representative scene and/or image even further.

### Other Features and Settings

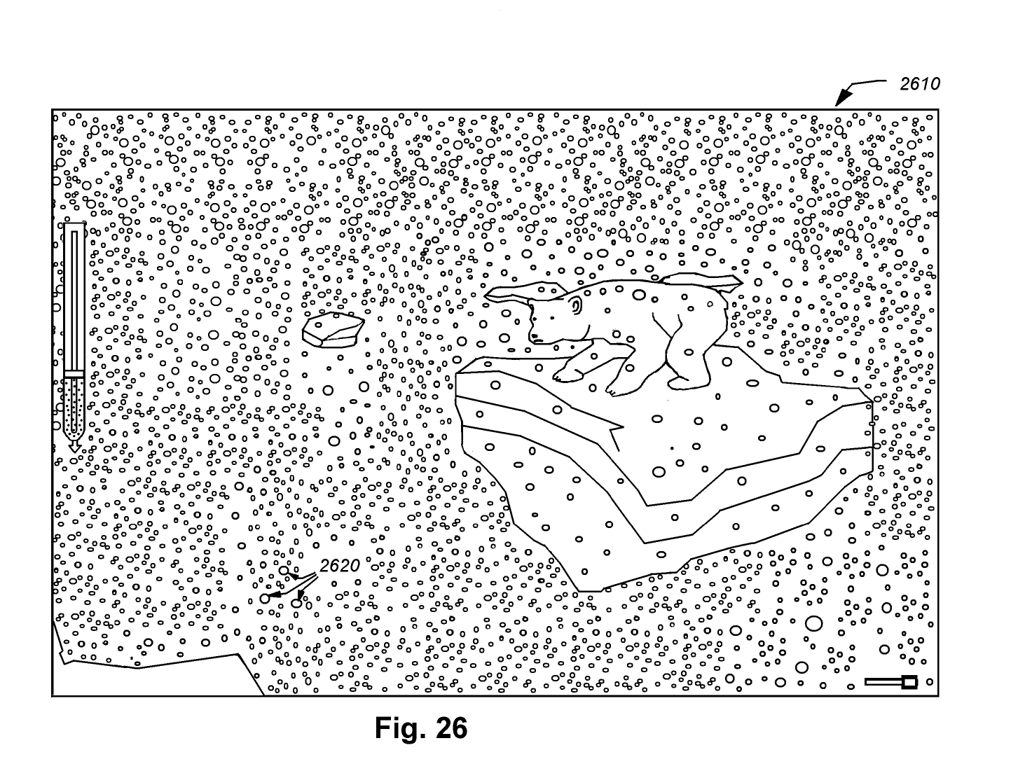

Having now described the features and method steps to carrying out the above-described invention, other features and advantages will now be described. FIGS. 26 and 27 show a diagram of a three-dimensional graphical user interface display showing an environmentally-enhanced mood-representation scene, in which the mood-representation scene displays a variety of factors, including not only the consumption data mood score, but also the environment (i.e. snowing, night/dark, and any other environmental factors) to further enhance the display for the interested individual. As shown in FIG. 26, the display 2610 is snowing, indicating that the weather at the polling location is the same (snowing). The snow 2620 further enhances the mood-representative scene by creating a further emotional connection between the interested individual and their resource consumption. FIG. 27 also reflects the environment, in terms of time of day, by the display 2710 being in a night environment 2720, representative of the time of day of the polling location. These additional features further enhance the emotional connection that a viewer of the three-dimensional scene has with the effect of their resource consumption on the environment. In this manner, an interested individual is emotionally connected with the bear environment, and further motivated to reduce their resource consumption.

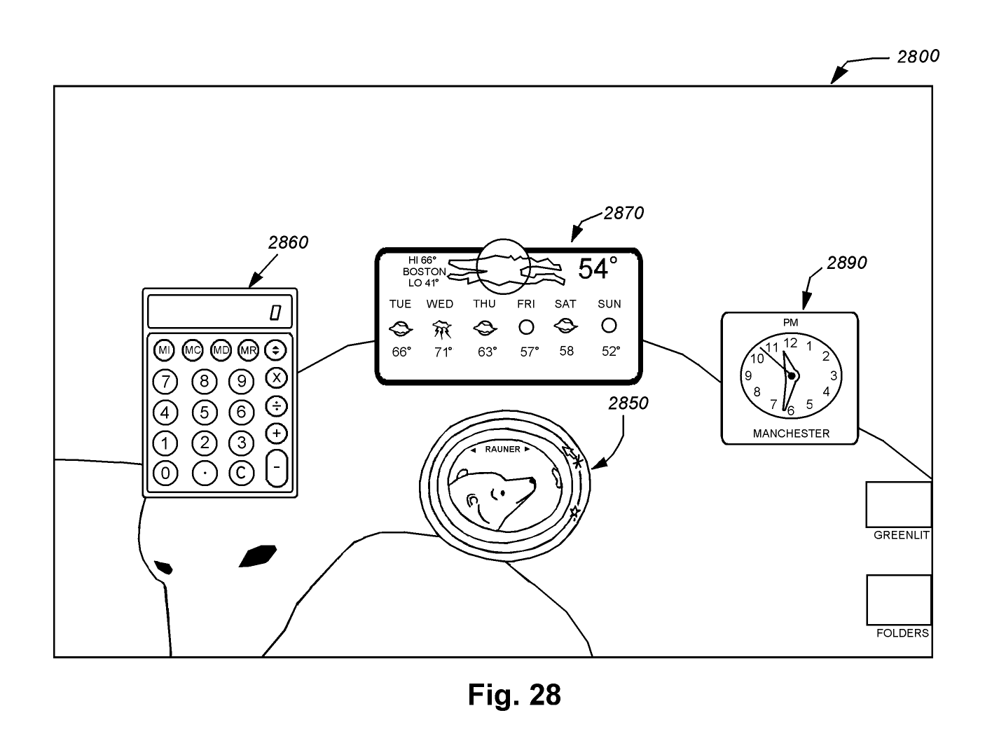

FIG. 28 is a diagram of a graphical user interface display 2800 including a widget that display a mood-representation image, in which the widget resides on a desktop or other image device, in a smaller display format. The widget 2850 provides interested individuals with one type of display, and can be easily incorporated into an existing system, to be displayed on their desktop computer. The widget 2850 can be provided on a display along with a plurality of other desktop items, such as a calculator 2860, weather icon 2870 and a clock 2890. As shown, the widget 2850 is part of an overall desktop, to display the mood to an interested individual easily, while they are simultaneously utilizing other applications on the computer, including the calculator 2860, weather application 2870 and clock 2890.

As discussed previously, the system administrator can specify the type of mood and analysis application to be employed for determining the mood score of a stage of consumption. FIG. 29 is a diagram of a graphical user interface display 2900 showing a competition-based image representative of consumption relative to others, in which the bears are shown graphically on a platform arrangement. As shown, the polling location that has the least amount of consumption is represented by the polar bear 2910 in first place on the platform 2915. Note the bear 2910 in first place has a large smile 2918 on his face, indicating the pleasure of wining the resource consumption competition. Note the bear 2920 in second place on the platform 2925, with a sad look on their face as they are only in second place. The polar bear 2930 in third place, atop the third place platform 2935, is deeply saddened, as shown in the image screen 2900, by his third place in terms of resource consumption. In this manner, interested individuals are motivated to reduce their resource consumption to be placed first on the platform. This creates a friendly type of consumption, particularly useful in dormitory, and other multi-person dwellings, in which consumption of resources is high and desired to be decreased.

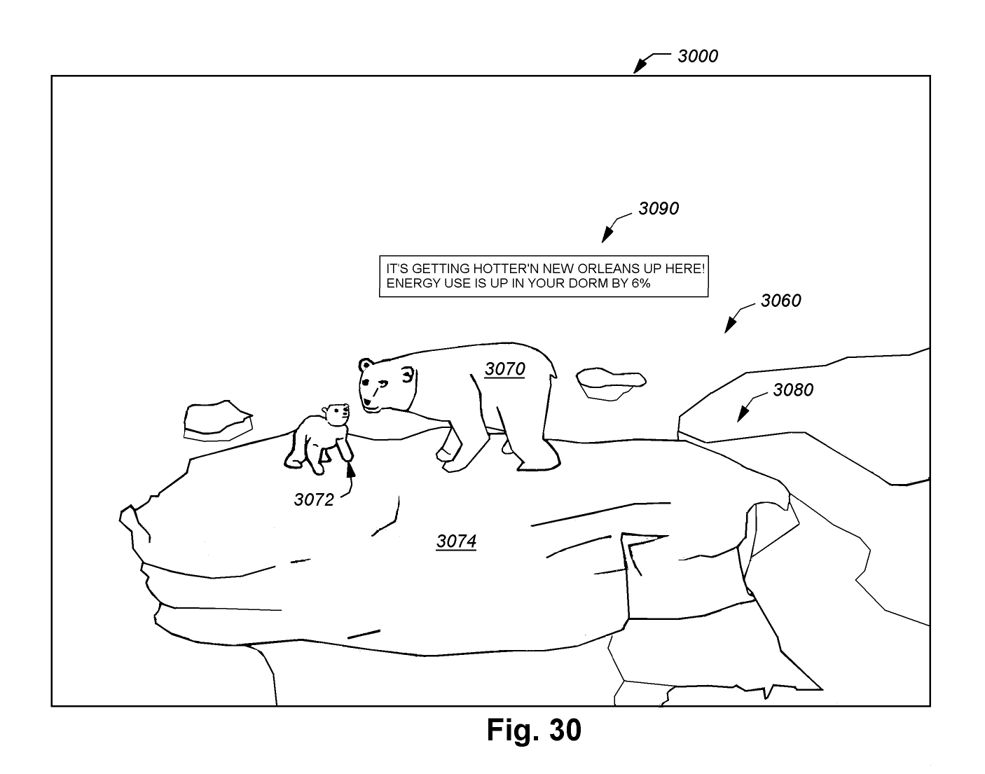

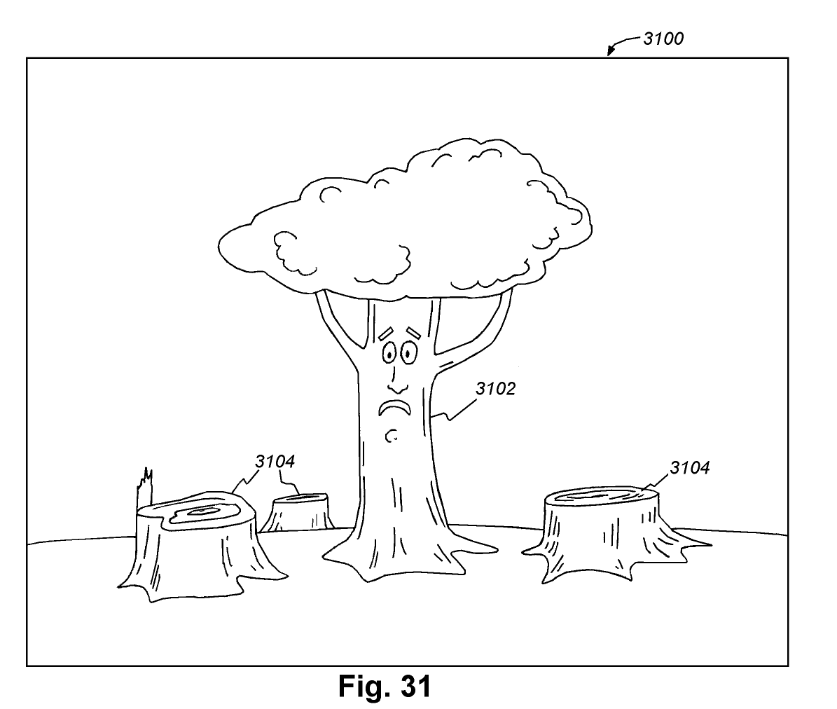

To further motivate interested individuals to reduce their resource consumption, the displays of mood-representative images and/or scenes may be presented on a touch screen display 3000, such as that shown in FIG. 30. The display 3000 is a three-dimensional graphical user interface display that employs a touch-screen (or another interactive platform) to monitor resource consumption and further allows an interested individual to employ the touch-screen to view advice for reducing their resource consumption. A person can touch the screen at any appropriate location thereon, to perform the interaction with the display. As shown, the image 2760 provides the mother bear 2770 and her cub 2772 on the ice 2774, evincing a somewhat distressed appearance. The viewer's finger 2780 has tapped the screen and thereby activated the image and an associated text message (text box 2790) that comports with the graphical mood image portrayed by the bears 2770, 2772. The message (or other animations/content described above) reinforces the general message conveyed by the emption-influencing pictorial/animated content (pouting bears) of the overall image. In general, additional content, such as text, can also include tips for reducing resource consumption, the current mood (as shown), progress toward a goal or any other displayable, system-administrator-defined content. This content can be based upon the type interaction between the system and the user. As noted above, a variety of techniques can be used to produce the above-described images and additional content in accordance with ordinary skill. For example, using the Unity engine, the depicted display can be encoded in the C Sharp programming language using a .NET framework. Likewise, using Flash, the depicted display can be encoded using ActionScript scripting language available through ActionScript.org.

According to another embodiment, the systems, methods and graphical user interface displays described herein can also be employed to monitor paper and/or ink consumption. A paper usage scheme or other resource consumption meter can be employed by the system, using standard Modbus TCP or through xml traversal of printer network addresses. The data is gathered using Modbus TCP or through the xml traversal to aggregated the polled data from one or more printers within a printing network. The one or more printers are polled to obtain appropriate data on a page counter (or other register identifying amount of paper or ink consumed) to determine the appropriate usage. Note that the information can be obtained from discrete printers, via polling of their individual device addresses and applicable data fields containing page consumption. Alternatively the information can be obtained by polling the appropriate data fields in a networked printer controller that maintains information of various printers within the overall network. In an example, a web service that maintains the addresses and information related to a large number (e.g. 1000 or more) printers can be polled for the appropriate paper (toner, etc.) consumption information.

The paper usage can be displayed to an interested individual in the manner as described herein to produce a mood-representative image and/or scene. One example of such a mood-representative image is shown in FIG. 31. The image screen 3100 of FIG. 31 shows a distressed environment, in which paper consumption is high. Note the tree image 3102 appears to be distressed and concerned about being cut down to be used as more paper, as the surrounding stumps 3104 have been cut down as well. This image screen 3100 provides an interested individual with a graphical display of their resource consumption, the resource being paper in this instance. The image screen for each resource being monitored is highly variable to reflect to an interested individual the impact their consumption is having on the environment.

In summary, a generalized method for creating a display of consumption behavior of a resource comprises the steps of (a) combining resource-consumption information from a plurality of sources of the resource; (b) providing a mood level relative to a plurality of factors derived from the consumption information; and (c) driving a graphical user interface display containing an emotion-inducing image that varies based upon mood level to thereby influence behavior of resource consumption of individual viewers of the display. Other systems and methods are expressly contemplated in accordance with the illustrative embodiments of this invention.

It should be clear that the system and method of this invention provides a highly versatile mechanism for influencing the behavior of individuals and groups and motivating them to work toward achieving a socially desirable goal by appealing to emotional responses based upon the presentation of sympathetic characters and images that respond in real-time or near-real-time o the current state of the groups behavior. This system and method employs one or more factors relating to consumption to create a mood. This mood is translated into an image that provides one or more dimensions of mode-influencing imagery based upon the one or more factors. The system and method can be displayed to groups and/or individuals on a wide range of displays and can be interactive for an even more-powerful viewing experience.

The foregoing has been a detailed description of illustrative embodiments of the invention. Various modifications and additions can be made without departing from the spirit and scope of this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, the graphical user interface displays provided herein have been in reference to a polar bear and polar bear-type environments, however the type of images and/or objects used in the mood-representative images and scenes are highly variable. They can comprise any image or scene capable of representing to an interested individual the mood score resulting from their resource consumption. Additionally, while the emotion-inducing displays, images and characters provided to interested individuals according to the illustrative embodiments described above, relate to moods derived from resource-consumption data and factors, the ability to generate and display mood-driven emotion-inducing graphics can be adapted to a wide arrange of other systems that involve desirable and undesirable behavior. Some such systems can involve automated monitoring, and others can involve full or particle human monitoring and entry of relative varying data. For example, the principles presented herein can be provided by automatic input or human input to provide the server environment with trash and recycling data (e.g. how many trash bags are produced per day in a given community and how many recycling bins are filled). These numbers can be derived and provided to the server environment by human observation and/or by an automated counting/weighing device. Other socially desirable goals can be monitored in similar ways (e.g. car mileage, alcohol consumption, etc.). Accordingly, this description is meant to be taken only by way of example, and not to otherwise limit the scope of this invention.

What is claimed is:

1. A system for real-time or near-real-time monitoring of resource consumption comprising:
a plurality of consumption monitoring devices, each associated with an interested individual or group of interested individuals, the consumption monitoring devices being operatively connected with the datastream of each of the plurality of consumption monitoring devices for respective consumption data and an aggregator that aggregates each datastream into predetermined consumption data sets with respect to each associated interested person or group of interested persons;
an administrator configuration site constructed and arranged to enable an administrator to set predetermined parameters with respect to the consumption data sets including parameters related to consumption behavior, the administrator configuration site being operatively connected with a mood and analysis application that, in response to the parameters and the consumption data sets, generates mood scores, each of the mood scores representing a predetermined mood that is related to a level of consumption of the resource; and
a graphical display, responsive to each of the mood scores, that provides variable emotion-producing images based upon a prevailing mood score.

2. The system as set forth in claim 1 wherein the graphical display is provided on at least one of a public display screen, a personal computer screen, and a hand-held device screen.

3. The system as set forth in claim 2 wherein the server environment is constructed and arranged to direct the graphical display related to at least one of the consumption monitoring devices the at least one of the public display screen, the personal computer screen and the hand-held device screen that is associated with the interested individual or group of interested individuals associated with the at least one of the consumption monitoring devices.

4. The system as set forth in claim 3 wherein the images define a character that displays an emotion-producing expression based upon the prevailing mood score.

5. The system as set forth in claim 4 wherein the images define a plurality of variable image elements that vary based upon a plurality of factors within the mood score, related to a plurality of factors relative to consumption of the resource.

6. The system as set forth in claim 5 wherein the display is provided to the interested individual or group of interested individuals that are connected with a predetermined portion of an overall community that consumes the resource monitored by the plurality of consumption monitoring devices.

7. The system as set forth in claim 6 wherein the mood score is determined, at least in part, based upon historical data with respect to consumption of the resource.

8. The system as set forth in claim 7 wherein the mood score is determined, at least in part, based upon consumption data with respect to other portions of a community consuming the resource and interconnected with the plurality of resource monitoring devices.

9. The system as set forth in claim 8 wherein the administrator site is constructed and arranged to provide includes parameters with respect to goals for resource consumption.

10. The system as set forth in claim 1 wherein the resource includes at least one item, the use of which is capable of monitoring for amount versus time.

11. The system as set forth in claim 10 wherein the resource includes at least one of electricity, water, fuel, and paper.

12. The system as set forth in claim 1 wherein the mood scores are determined, at least in part, based upon consumption behavior parameters with respect to the interested individual or group of interested individuals.

13. A graphical user interface for depicting consumption of at least one resource comprising:
a display having an image responsive to data received from at least one of a plurality of consumption monitoring devices devices, each of the consumption monitoring devices providing consumption information to a server environment within a desired time base, the display including an emotion-inducing character that varies emotional expressions based upon a mood score generated by the server environment in response to that data and administrator-set parameters for levels of consumption of the resource.

14. The graphical user interface as set forth in claim 13 wherein the administrator-set parameters include at least one of the historical consumption data, competitive data between a plurality of groups of users within an overall community of consumers of the resource, time of day, time of week, and season.

15. A method for creating a display of consumption behavior of a resource comprising the steps of:
(a) combining resource-consumption information from a plurality of sources of the resource;
(b) providing a mood level relative to a plurality of factors derived from the consumption information; and
(c) driving a graphical user interface display containing an emotion-inducing image that varies based upon mood level to thereby influence behavior of resource consumption of individual viewers of the display.
